(19) United States
(12) Patent Application Publication
(10) Pub. No.: US 2015/0246654 A1
(43) Pub. Date: Sep. 3, 2015

(54) TELEMATICS SYSTEM WITH 3D INTERTIAL SENSORS

(71) Applicants: Srdjan Tadic, Belgrade (RS); Dejan Dramicanin, Belgrade (RS); Branko Karaklajic, Uzice (RS)

(72) Inventors: Srdjan Tadic, Belgrade (RS); Dejan Dramicanin, Belgrade (RS); Branko Karaklajic, Uzice (RS)

(73) Assignee: PULSE FUNCTION F6 LTD, Foxrock, Dublin (IE)

(21) Appl. No.: 14/371,911

(22) PCT Filed: Jan. 13, 2012
(86) PCT No.: PCT/RS2012/000001

§ 371 Date: Jul. 11, 2014

(51) Int. Cl. B60R 21/0136; G01P 15/02; G01P 15/14

(52) U.S. Cl. CPC B60R 21/0136; G01P 15/14; G01P 15/02; B60R 2021/01325

(57) ABSTRACT

The present invention considers the telematics systems providing apparatus and operation methods for apparatus, including wireless, accelerometer and gyroscope capabilities offering: trajectory recovery on transportation vehicle in the case of the predefined event, specific driving event detections like drifting, side-slip, roll-over, abrupt turning, as well as driving under influence, inherently enhanced positioning of the vehicle, as well as capability to provide method for behavior analysis of the vehicle. Proposed method of operation being executed in cloud allows fleet management individual and sub-group behavior analysis, combined with ability of emergency related activities, as well as charging, remote system control and maintainance. Proposed solution is addressing apparatus and method of operation allowing “pay HOW your drive” vehicle operation.

### TECHNICAL FIELD

The present invention relates generally to the communication system (apparatus and method of operation) related to the telematics application using inertial sensors and the specific signal processing for a vehicle trajectory reconstruction after predefined events, as well as for an analysis of the diver behavior.

### BACKGROUND ART

Telematics communication systems usually and historically consider a system, where a movable asset (typically on transportation vehicle) consists of:
a) a remote unit being placed on a movable asset containing a global positioning system (global navigation satellite system in general), a cell phone transceiver, and recently a sensor connection, providing location and other information
b) a fixed station with a data base processing being connected by cellular means to a remote station

In the list of the recent patent applications and granted patents the state of the art topologies and method operations for telecommunication devices are elaborated.
US2002/0115436 A1 patent application describes a method of operation where telematics system detects events like ignition of a car or some other sensor information is transmitted to a base station.
US2004/0180647 A1 patent application describes a method of operation where telematics system is associated with identification of a transportation mean and pay per use technologies.
US2005/0075892 A1 patent application describes a method of operation where an area of a telematics system is associated with logistic related information to deliver specific improvements of the operation processes.
US2005/0130723 A1 patent application describes apparatus and method of operation for telematics applications that include positioning, routing as well as security and emergency notifications.
US2005/0118056 A1 patent application describes a telematics box apparatus based on state of the art functionalities combined with audio communication functionalities and specific a method of operation.
U.S. Pat. No. 6,871,067 patent presents a method and system for dispatching telematics messages. This patent describes the remote box functionality with basic approach of being connected to the vehicle internal bus.
U.S. Pat. No. 6,912,396 patent describes vehicle telematics radio and associated method of operation, whereby the blocks of a remote box are outlined to have a memory, a processing entity, interfaces, a cellular connection and a GPS functionality.
U.S. Pat. No. 6,957,133 patent describes small scale integrated vehicle telematics device, which has almost the same hardware topology as in the U.S. Pat. No. 6,912,396.
U.S. Pat. No. 7,236,783 patent considers a similar HW topology for the telematics unit being associated to a vehicle to U.S. Pat. Nos. 6,912,396 and 6,957,133. In this patent a method for provisioning a telematics unit is described.
U.S. Pat. No. 7,355,510 patent describes a telematics system and vehicle tracking solution using basic vehicle telematics device topology same as described in U.S. Pat. Nos. 6,911,2396, 6,957,133 and 7,236,783.
U.S. Pat. No. 7,787,74 patent describes a portable telematics device, which utilizes new functionalities within the basic topology of a telematics device, like digital video broadcasting and audio. EP 0590312 patent application describes grade angle and acceleration sensors for automotive usage.
U.S. Pat. No. 6,067,488 describes a driving recorder, where the angular velocity data and acceleration data of a vehicle are sequentially measured and stored into a memory along with time related information, thereby updating the data stored in the memory in a sequence of occurence.

### DISCLOSURE OF INVENTION

The presented invention considers a telematics systems providing apparatus and methods of operation capable of delivering the following functionalities and/or capabilities:
a) trajectory recovery of a remote unit being mounted on a transportation vehicle, especially after a crash event occurrence
b) detection of specific driving or vehicle events, especially those related to the: stability of a vehicle, crash of a vehicle, used road, driving under the influence, driving under the influence of fatigue, driving under health problems as specifically outlined.
c) inherently enhanced positioning of a vehicle, in the case of the outage of the global navigation satellite systems ( ) or in a case when a position is required for specific calculations between two positions supplied by global positioning systems
d) capability to provide related solution independently from the vehicle own communication system
e) capability to use the data from a vehicle, if the interface for gathering this information is available
f) capability to provide additional information regarding the operation of a vehicle
g) capability to asses driver behavior, statistically in the predefined time periods under different geographical, environment and other conditions, including driving under influence, fatigue or non prescribed manner
h) capability to issue pre-crash and warnings to drivers
i) capability to issue alerts with extended information set compared to the state of the art solutions to the “out of the vehicle” environment.

by utilizing innovative proposed hardware architecture containing as key element 3D inertial sensors and gyroscopes by the plurality of realization (preferable using MEMS Technologies), and innovative proposed signal processing, combined with proposed method of operations. Signal processing are related specific method of operations where information from the sensors, combined with location information and optionally vehicle data are processed, and decisions of the particular pre-defined events is taken.

In contrast to the State of the Art the presented invention provides an innovative step in presented solutions (new apparatuses topologies and methods of operation), to address the new features regarding vehicle operations and its tracking and consequently new applications and new business processes. The new functionalities and addressing the new features are covered by introducing the specific HW topology for remote vehicle telematics device, specific signal processing solution (described by method of operation options), as well as specific innovative operation method for introducing new business processes options.

Proposed system in contrast to the state of the art telematics solutions described in previous patents (HW solution combined with specific Method of Operation) may be advantageously used for the applications in the following fields:
Support information for insurance companies, addressing driver behavior (cost/risk optimization), as well as vector trajectory reconstruction in case of specific events (damage regulation optimization) and as
Support information for service companies, leasing companies, and fleet management systems, where the driver behavior may play important role in the optimization, person safety, public safety as well as of the cost of operations and risk minimization. The proposed solution is able to address driver behavior in statistical but also in particular way, meaning that dangerous driver, driver not compliant with the pre-defined (public or internal) rules as well as driving under influence or driving with acute health related problems may be analyzed, and specific measures may be initiated.
Support information for the safety bodies, public and private organization, who may used the driver information behavior to optimize the traffic loads with specific environmental solution, by specific changing mechanism, where not only presence on specific geographical area is charged, where also specific speed by using those areas is charged, or where particular fine system by driving dangerously or against predefined rules are applied.
Support information for private people or people organizations without commercial interest
Information being able to improve private safety of the person (in the vehicle) and public safety (outside of the vehicle)

### BRIEF DESCRIPTION OF DRAWINGS

FIG. 1 Operation Environment of the Telematics System

FIG. 1 shows a typical operation environment of Telematics systems, containing telematics box, being placed within the vehicle, means of long range wireless communications, typically cellular systems, and Data Base System, where the information obtained through telematics box (T-box) is processed and as such stored or provided as available to the user through proprietary or public access. This operation environment applies also to the proposed invention.

FIG. 2 State of the Art Telematics Box (T-Box) Being Placed Inside the Vehicle

FIG. 2 shows typical state of the art T-box known from the literature, patent applications, granted patents and publicly available data. Basically, the T-box contains the obligatory part which means a receiver for global position system (or systems), long range wireless communication transceiver, and controlling & processing unit. The “state of the Art” T-Box reported so far contains optional features to be connected to external sensor (which is a part or the vehicle system or being placed as associated to the T-Box) to poses optional memory for storing the data (typically for the purposes of booting the systems, identification, control and maintenance features, or for storing the position related data or other temporary data) before transferring it through long range wireless means. Optional interfaces to the vehicle own systems typically through OBD I or OBD II Interface are outlined.

FIG. 3 Proposed Telematics Box (T-Box) (1000) Being Placed Inside a Vehicle

FIG. 3 contains a part of the proposed apparatus for T-Box, being included as a part of the general telematics systems as depicted in the FIG. 1. Proposed T-Box (1000) has three parts the “obligatory part of the T-box” (100), “6 degrees of freedom inertial unit” (200) and Optional functionalities (310, 320 and 330). Part (100) and Part (200) in combination are the key innovative part of the HW subsystem of the complete proposed system.

FIG. 4 Proposed Telematics System Method of Operation (10000)

FIG. 4 contains a logical description of the Telematics System Method of Operation (10000) and the separation of Telematics System Method of Operation form logical descriptions of the Method of Operation of proposed T-Box (11000) and Method of Operation of the Back End (12000), which is related to the activities to be performed and executed in the system which are not physically executed on the proposed T-Box (1000), but rather on a virtual information network.

FIG. 5 Proposed Method of Operation Activities (11000) Being Executed on the Proposed T-Box (1000).

FIG. 5 shows activities being performed on the T-Box (100). Related Processor & Control Unit (130) and Memory (310) are the major HW blocks of the proposed T-Box (1000), which are executing specific activities as a subset of all activities regarding proposed Telematics System Method of operation (10000). Input information, output information and description of the activities are presented in structured way.

FIG. 6 Proposed Method of Operation Activities (11100) “Calculation of Real Time Position Data”

FIG. 6 shows activities related to the real time position data calculations, which are based on inertial system supplied information and delivered by specific signal processing activities.

FIG. 7 Proposed Method of Operation Activities (11200) “Calculation of Real Time Vector Trajectory of a Vehicle”

FIG. 7 shows activities related to the calculation of vector trajectory of a vehicle using information from inertial system and specific signal processing activities.

FIG. 8 Proposed Method of Operation Activities (11300) “Calculation of Behavior of the Driver & Vehicle” PART I and

FIG. 9 Proposed Method of Operation Activities (11300) “Calculation of Behavior of the Driver & Vehicle” PAR II

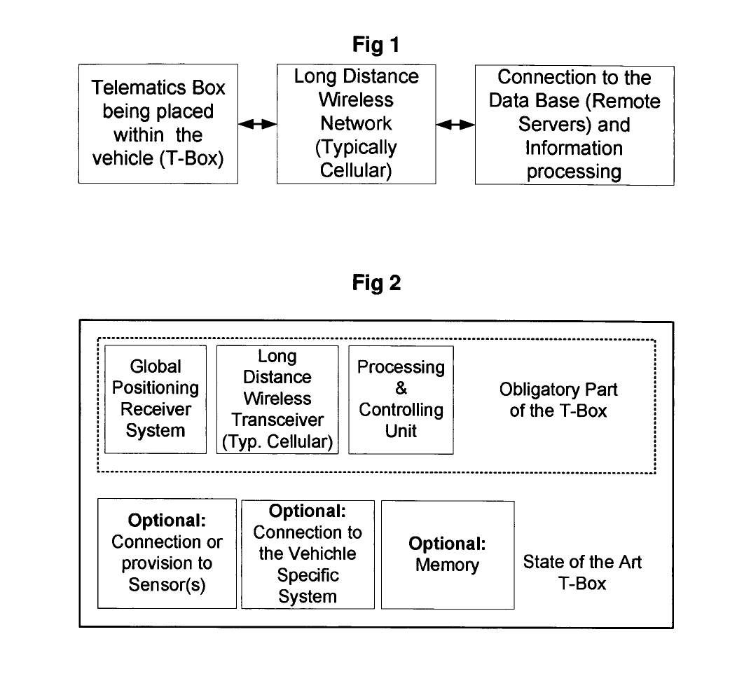

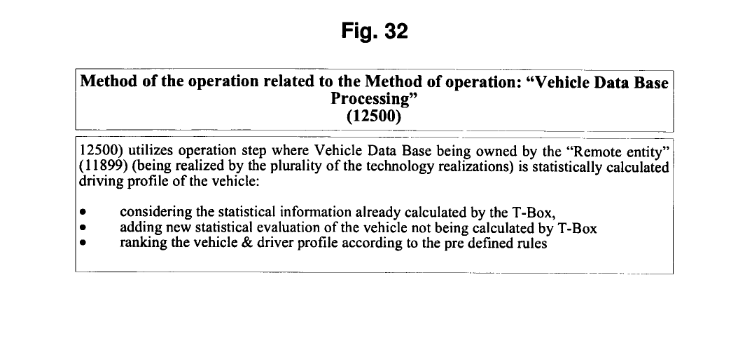

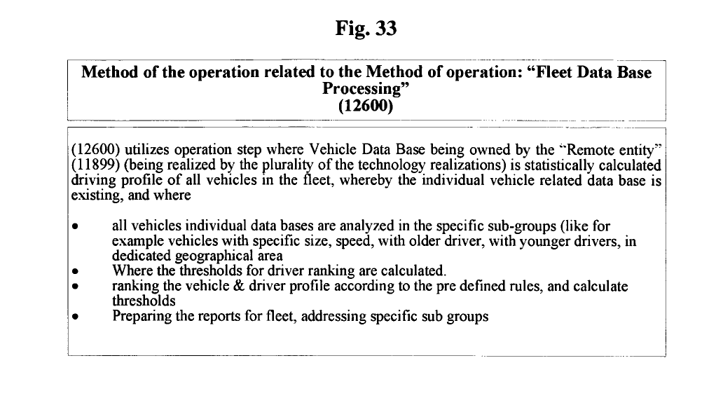

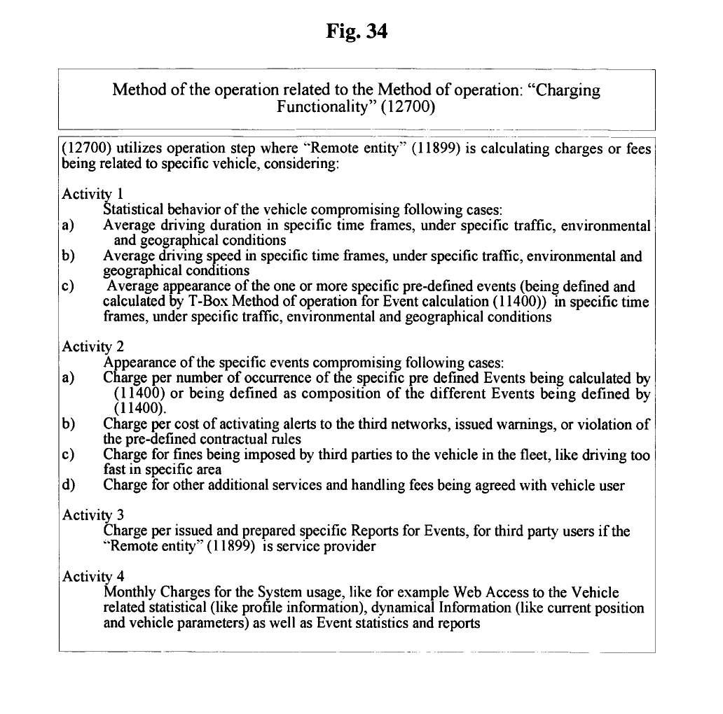

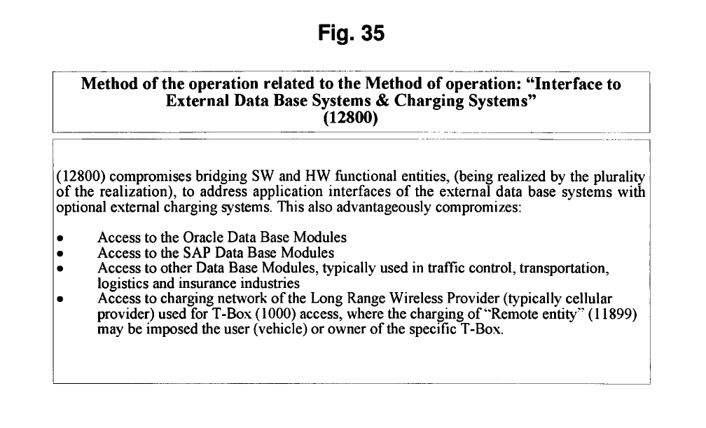

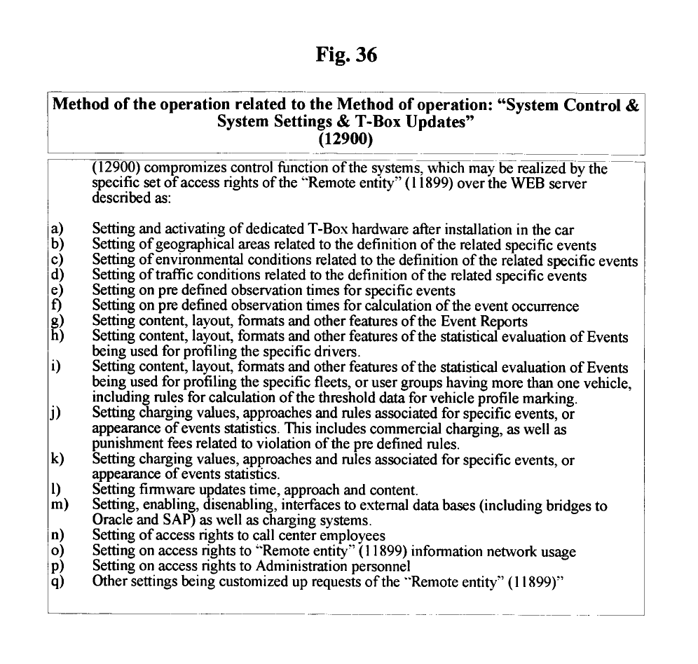

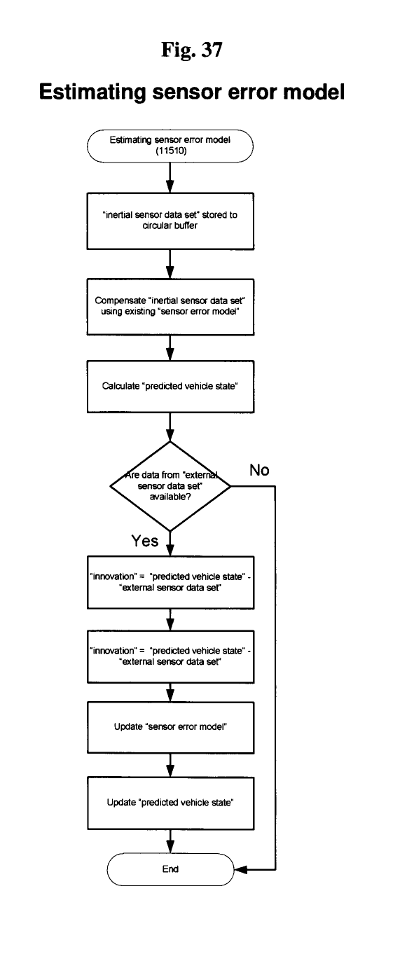

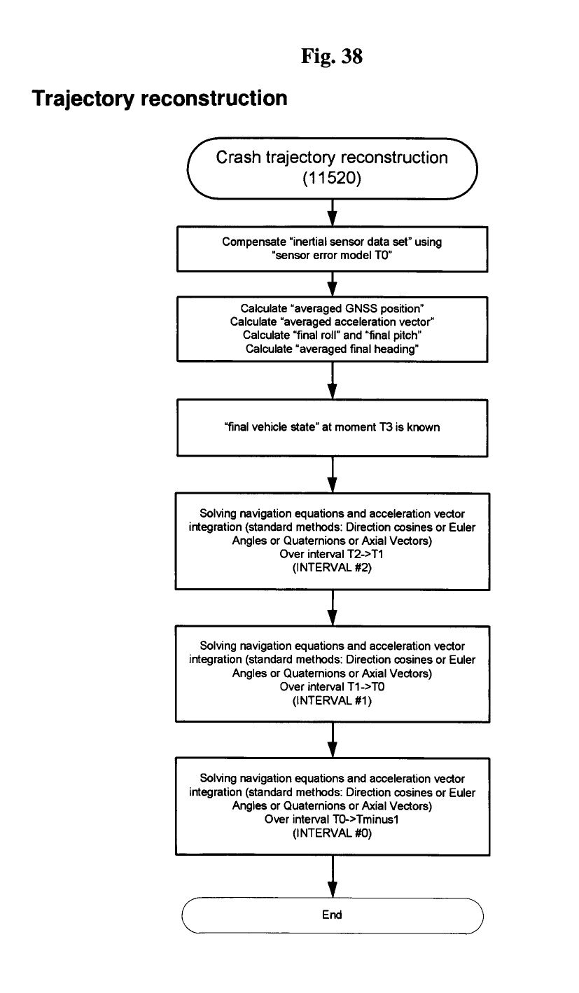

FIGS. 8 and 9 shows activities related to the calculation of statistic behavior of the vehicle using information from inertial system and specific signal processing activities. The different categories of the events and dynamic features are processed.

FIG. 10 Timeline and Identification of Important Intervals During Crash Event

FIG. 10 shows timeline used in “Post event calculation of vehicle Vector Trajectory”(11500) activities and specifies a naming convention of identified time intervals before, during and after crash.

FIG. 11 Coordinate Frame Orientation

FIG. 11 shows orientation of coordinate frame as used in all proposed methods of operation and activities and in all claims and description text unless specified otherwise.

FIG. 12 Proposed Method of Operation Activities (11411) “Roll-Over Event Detection”

FIG. 12 shows activities related to the calculation of roll-over event belonging to the category of stability events (11410).

FIG. 13 Proposed Method of Operation Activities (11412) “Pitch Event Detection”

FIG. 13 shows activities related to the calculation of pitch event belonging to the category of stability events (11410).

FIG. 14 Proposed Method of Operation Activities (11415) “Understeering Event Detection”

FIG. 14 shows activities related to the calculation of understeering event belonging to the category of stability events (11410).

FIG. 15 Proposed Method of Operation Activities (11421) “On-road & Off-road Usage Event Detection”

FIG. 15 shows activities related to the calculation of on-road and off-road usage event belonging to the category of “road type and vibration monitoring” events (11420).

FIG. 16 Proposed Method of Operation Activities (11422) “Moderate Risk of Back Disorders” and (11423) “High Risk of Back Disorders”

FIG. 16 shows activities related to the calculation of risk of health assessment due to vibrations belonging to the category of “road type and vibration monitoring” events (11420).

FIG. 17 Proposed Method of Operation Activities (11431,11432) “Non-Severe Crash Event Detection”

FIG. 17 shows activities related to the calculation of non-severe crash event belonging to the category of “Crash” events (11430).

FIG. 18 Proposed Method of Operation Activities (11431,11432) “Severe Crash Event Detection”

FIG. 18 shows activities related to the calculation of severe crash event belonging to the category of “Crash” events (11430).

FIG. 19 Proposed Method of Operation Activities (11431,11432) “Severe Crash Event Classification”

FIG. 19 shows activities related to the classification of severe crash events belonging to the category of “Crash” events (11430).

FIG. 20 Proposed Method of Operation Activities (11441) “Driving Under the Influence Event Detection”

FIG. 20 shows activities related to the calculation of driving under the influence events belonging to the category of “Driver Related” events (11440).

FIG. 21 Proposed Method of Operation Activities (11442) “Driving Fatigue Event Detection”

FIG. 21 shows activities related to the calculation of driving fatigue events belonging to the category of “Driver Related” events (11440).

FIG. 22 Proposed Method of Operation Activities (11500) “Post Event Calculation of Vehicle Vector Trajectory”

FIG. 22 shows activities related to the calculation of post-event calculation of the vehicle trajectory (helping to establish reconstruction of a trajectory before the event occurence)

FIG. 23 Proposed Method of Operation Activities (11600) “Optional Calculation of Pre-Event Warning to Vehicle System (Driver)”

FIG. 23 shows activities related to the calculation of pre-event warnings to the driver and to the back end (“out of the vehicle” information network).

FIG. 24 Proposed Method of Operation Activities (11700) “Optional Realization of Encryption and Multimedia Compressions”

FIG. 24 shows activities related to the encryption and multimedia related features of the proposed system.

FIG. 25 Proposed Method of Operation Activities (11800) “Optional Initialization of Event related Alerts”

FIG. 25 shows activities related to the Alerts being provided to the out of vehicle board and to the in the driver or vehicle. FIG. 26 Proposed “Back End” Functionality (2000).

FIG. 26 shows functional and logical sub-entities of the “Back End” Functionality (2000), where Method of Operation Activities (12000) are executed.

FIG. 27 Proposed Method of Operation Activities (12000) Being Executed on the Proposed Back End Functionality (2000).

FIG. 27 shows Method of Operation Activities (sub-groups of activities) being executed on “Back End” (2000)

FIG. 28 Proposed Method of Operation Activities “Back End Alerts Actions” (12100) Being Executed on the Proposed Back End Functionality (2000).

FIG. 29 Proposed Method of Operation Activities “Back End Event Actions” (12200) being executed on the proposed Back End Functionality (2000).

FIG. 30 Proposed Method of Operation Activities “Event Report Preparation and Handling” (12300) Being Executed on the Proposed Back End Functionality (2000).

FIG. 31 Proposed Method of Operation Activities “Location Based Visualization systems” (12400) Being Executed on the Proposed Back End Functionality (2000).

FIG. 32 Proposed Method of Operation Activities “Vehicle Data base Processing” (12500) Being Executed on the Proposed Back End Functionality (2000).

FIG. 33 Proposed Method of Operation Activities “Fleet Data Base Processing” (12600) Being Executed on the Proposed Back End Functionality (2000)

FIG. 34 Proposed Method of Operation Activities “Charging Functionality” (12700) Being Executed on the Proposed Back End Functionality (2000)

FIG. 35 Proposed Method of Operation Activities “Interface to External Data Base Systems & Charging Systems” (12800) Being Executed on the Proposed Back End Functionality (2000)

FIG. 36 Proposed Method of Operation “System Control & System Settings & T-Box Updates” (12900) Being Executed on the Proposed Back End Functionality (2000)

FIG. 37 Proposed Method of Operation Activities (11510) “Estimating the Sensor Error Model”

FIG. 37 shows activities related to the calculation of the sensor error model belonging to the category of “Post-event trajectory reconstruction”(11500).

FIG. 38 Proposed Method of Operation Activities (11520) “Crash Trajectory Reconstruction”

FIG. 38 shows activities related to the calculation of trajectory of vehicle just before a crash, during the crash and after the crash belonging to the category of “Post-event trajectory reconstruction”(11500).

### DETAILED DESCRIPTION OF THE INVENTION

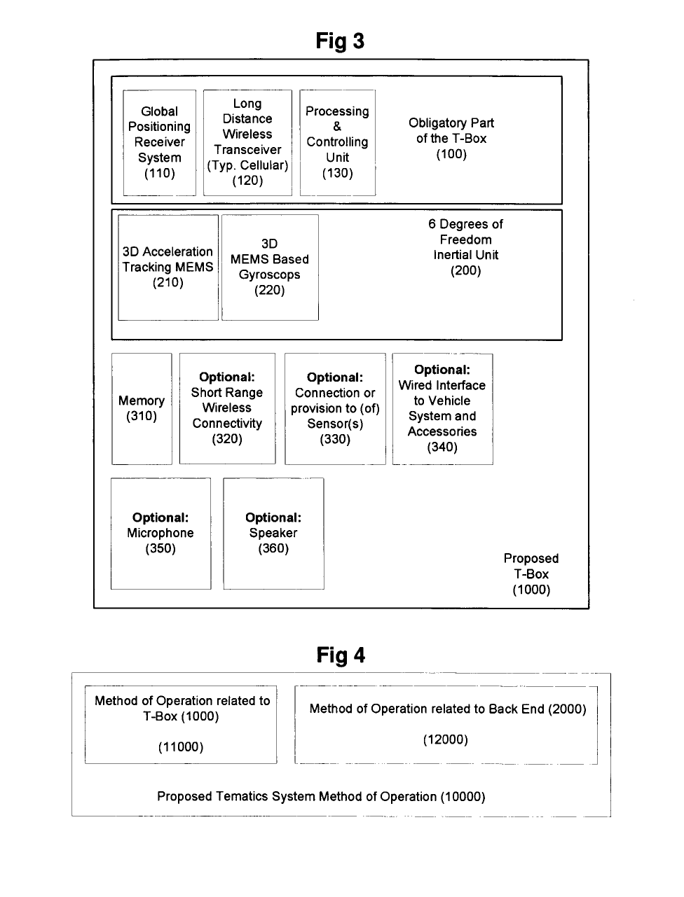

Proposed invention relates to the system being capable to provide
Vector trajectory recovery of the mounted remote unit being mounted on a or within a transportation vehicle, in two cases: real time” and in the post processing mode, after specific predefined event (like crash) has happened.
Detections of specific driving events
Inherently enhanced positioning of the vehicle, in the case of the outage of the global positioning systems (by plurality of their applications), or in the case when a position is required for specific calculations between two positions supplied by global positioning systems
capability to provide related solution independently from the vehicle own communication system
capability to use the data from the vehicle (if the interface for gathering the information is available)
capability to provide additional information related to operation of the vehicle
capability to provide warning information to the driver or to the backend, related to a predefined event
capability to provide a driver behavior analysis, by calculating occurrence of the predefined events in the pre-defined time frames
capability to send alerts related to a specific group of events to “outside of the vehicle” information network and to the driver.
by utilizing:
   a) Telecommunication Box (T-Box) shown in FIG. 3 (1000)
   b) Specific Method of Operation shown in FIG. 4 (2000).

T-Box (1000) contains “obligatory part of the T-box” (1000), “ 6 degrees of freedom inertial unit (200) and Optional functionalities (310, 320 and 330). T-Box (1000) is mounted within the vehicle by the plurality of the mounting options. T-Box (1000) may be installed in an after-market process within the vehicle; meaning after the complete vehicle as such is fully assembled, or may be in a process of the vehicle assembly integrated up to a degree of a integral vehicle part. The T-Box (1000) is connected to the vehicle DC power supply. The T-Box (1000) can but not necessarily must be connected to the vehicle controlling and processing system (option). T-Box (1000) has its enclosure with electrical and mechanical interfaces. The minimal electrical interface needs to be composed of power supply connection, obtained from within a vehicle. The mechanical interface contains the means of placing the T-Box (1000) within the vehicle. The enclosure of T-Box (1000) may be designed in a way to provide for an optional capability of electromagnetic waves from satellite systems (location) and from long range wireless functionality to pass through it, enabling the related antennas to be placed inside the enclosure or the usage of connectors in order to place the stated antennas outside the enclosure, within or on the top of a vehicle.

“Obligatory part of the T-box” (100) contains: Global positioning System Receiver (110), Long Distance Wireless Transceiver (120) and Processing & Controlling Unit (130). Global positioning system receiver (100) contains functionality of receiving satellite signals to calculate a position of the T-box. At least one of the satellite systems, GPS, Galileo, GLONASS, COMPASS, QZSS with specific accuracy enhancement functions must be used. The overall position may be derived from combination of information from different satellite location systems. Functionality (110) may be realized within the T-Box either by a module providing localization data (geographical coordinates) or or by providing signals to the processing unit (130), which has SW processing part for the calculation of the location data, besides other independent functions it undertakes. Functionality (100) may be realized by the plurality of the technologies and use both antenna options: an integrated antenna or external antenna connected over a connector. This external antenna may be placed inside of the T-Box (100) enclosure (outside of the GNSS module where Functionality (110) is realized) or outside of the enclosure, meaning inside or on the top of the vehicle.

Long Distance Wireless Transceiver (120) contains functionality of receiving and transmitting data (including raw data, and for audio signals and/or video signals, with or without compression and with inherently imposed and optionally added additional encryption. Long Distance Wireless Transceiver (120) typically is using cellular (mobile communication network) connectivity by the one or combination of systems:
a) generation 2 mobile communication System (GSM, GPRS)
b) Generation 2,5 (EDGE)
c) Generation 3 (UMTS, WBCDMA, HDCPA)
d) Generation 4 (LTE)
or systems like WiMax,
or Satellite Communication systems,
or other data transfer radio system characterized by the fact that the guaranteed minimum wireless communication distance between functionality (120) is larger than 500 m. Functionality (120) may be realized by the plurality of the technologies and and use both antenna options: an integrated antenna or external antenna connected over a connector. This external antenna may be placed inside of the T-Box (100) enclosure (outside of the radio module where Functionality (120) is realized) or outside of the enclosure, meaning inside or on the top of the vehicle.
The functionality (110) and the Functionality (120) may be realized and utilized in the T-Box (1000) as a single module.

Processing & Controlling Unit (130) is realized by the plurality of CPU solutions, whereby preferably a 32 Bit Processor technology optionally combined with DSP is recommended.

The CPU processor can use no operating system or can use an operating system, which may be based on Linux, Microsoft based OS or other type of OS like RTOS, VX Works, Android. Preferably an Embedded Linux solution is recommended.

“6 degrees of freedom” (200) inertial unit is an essential innovative feature of the proposed apparatus and method of operation. “6 degrees of freedom” (200) functionality contains two major functional blocks being realized by the plurality of realization options: “3D MEMS accelerometer” (210) and “3D MEMS gyroscope” (220). “3D MEMS accelerometer” (210) functionality may be realized physically by using a single chip, more than one chip (typically one per direction/axis) or a module based on MEMS accelerator sensors. “3D MEMS gyroscope” (220) functionality may be realized physically by using a single chip, more than one chip or a module based on MEMS Technology. The usage of the devices being realized by MEMS technology (Micro Electro-mechanical Sensors) or NEMS (Nano Electro-mechanical Sensors) essentially enable small size and light weight realization of the devices and its easy assembly of the proposed T-Box (1000) PCB assembly. Functionality (210) and (220) may be provided as a single chip or a single module solution by the plurality of realization and interfaces, but having common innovative feature of utilizing MEMS technology as a key enabler.

Memory (310) functionality may be realized by the plurality of the memory technologies and can be realized as a part of the inside memory within the Functionality (130) and therefore it may be claimed as an optional part. The functionality (310) is providing HW resources for one or combinations of at least two of the following features:
Temporary storing the date before transmission over long range wireless functionality (120)
Storing the identification data of the vehicle
Storing access, maintenance, and service data
Storing business process relevant data
Driving Event Data Records related to q specific vehicle, in which the T-Box (1000) is mounted
Event data profiles required to detect and react upon an specific event
Location based information with time stamps related to a specific vehicle in which the T-Box (1000) is mounted
Driver behavior data associated to the specific pre-defined events with time stamps or statistically evaluated without time stamps
Vehicle dynamic (speed vectors and acceleration vectors) data being associated to the specific pre-defined events

“Short range wireless connectivity” (320) optional functional block allows short range wireless data exchange between proposed T-Box (1000) and a remote unit, whereby the remote unit is maximally 500 meters away from the T-Box unit. Typical communication distance of the functionality (320) is less than 20 meters and may be realized by the plurality of the short range wireless solutions.

Options for related short range wireless solutions are at least one or combination of two or more of the bellow:
Bluetooth System in 2,4 GHz Band by the plurality of Bluetooth options (ISM Band)
WLAN Systems in 2,4 & 5 GHz Band by the plurality of WLAN realization option (ISM Band)
ISM Band Systems in 433 MHz, 866 MHz, 315 MHz, 915 MHz using typically protocols with limited duty cycles and typically 200 kbit/s max raw data rate in communication
UWB systems in 3-10 GHz range
60 GHz 24 GHz communication systems
24 GHz communication systems
60-80 GHz Radar Systems
24 GHz Radar Systems

Proposed Wireless Connectivity Functionality (320) as an option allows following major features, preferably required for the proposed Method of Operation to be delivered:
wireless connectivity to in-vehicle system; T-Box may obtain internal information from the vehicle systems and use it for the purposes like: event detection and related actions, typically pre crash or pre event warnings or evaluation of the vehicle parameters with dedicated time stamps
Wireless connectivity for additional sensors which may also be understood as system accessories, like wireless camera connection, or driving environment sensors
Wireless connectivity to driver own independent personal information device (PDA, Smart Phone or similar)
Providing sensory activity by itself for purposes of distance calculations or object recognition, by deploying external connectors for additional antenna systems.

Proposed optional “Connections of the provision to (of) sensor(s)” (330) contains wired means of connection to a specific non inertial sensor, being placed in the T-Box (1000) itself or outside of the T-Box (1000), like for example environmental factors sensors.

Proposed optional “Microphone” (340) contains a microphone entity by the plurality of the realization and technologies. It is used by audio an capture activity of the Method of Operation.

Proposed optional “Speaker” (350) contains a speaker entity by the plurality of the realization and technologies. It is used to issue alerts form the T-Box to the vehicle and the driver or to transmit alerts form the Back End functionality (2000) to the vehicle and the driver, which are described by the proposed Method of Operation.

Proposed optional “Wired Interface to vehicle system and accessories” (340) comprises of wired means for connection of the T-Box (1000) to vehicle systems or accessories by at least one of the means:
Vehicle OBD Connector
CAN Interface
Lin Interface
FlexRay Interface
MOST Interface
SPI Interface
RS232 Interface
USB Interface

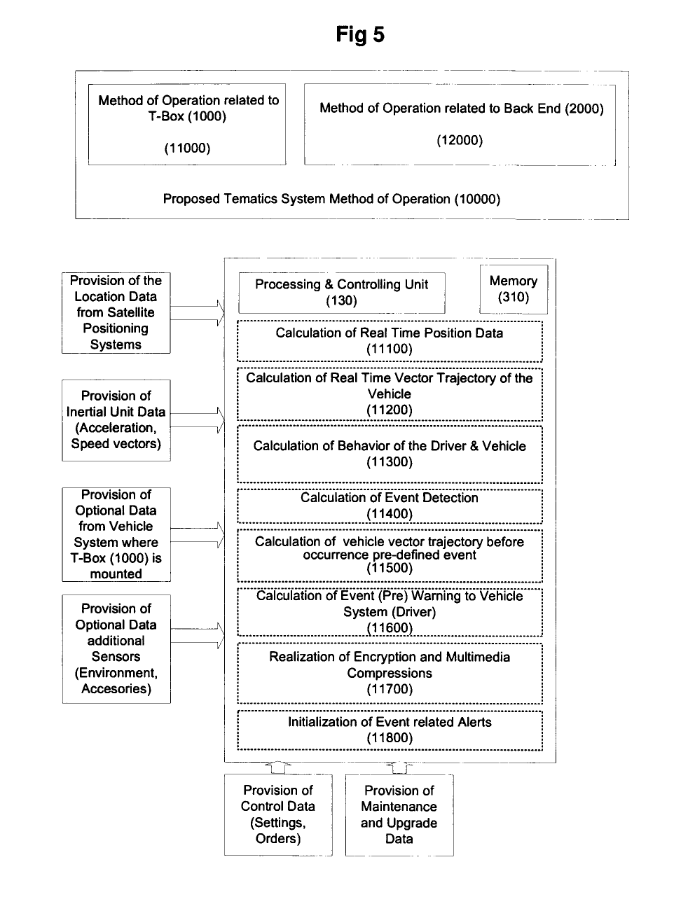

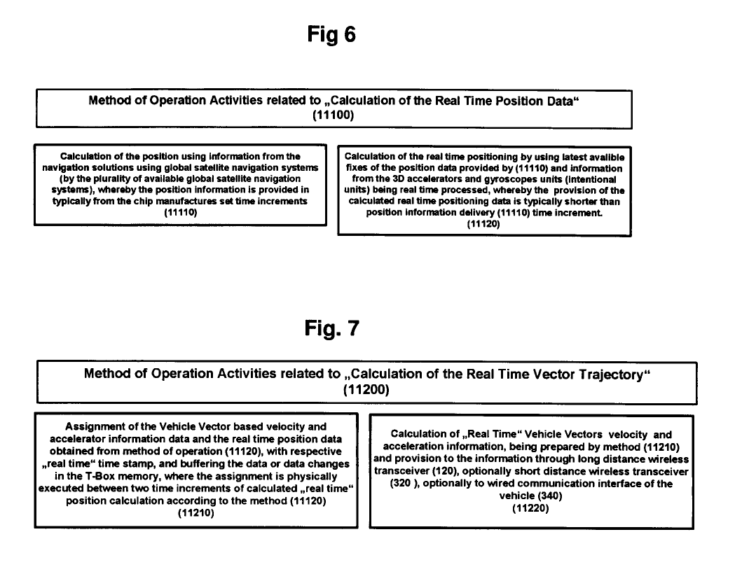

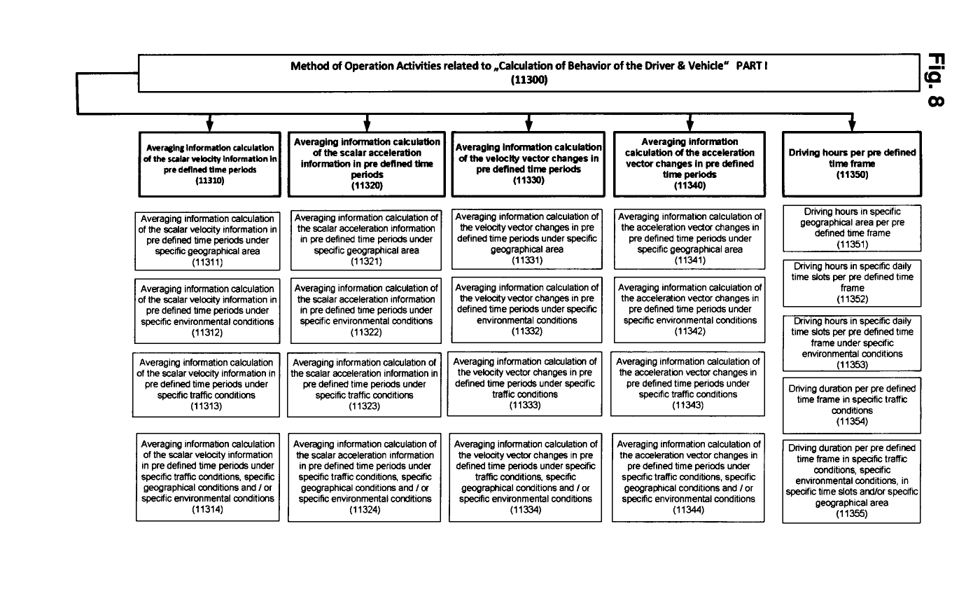

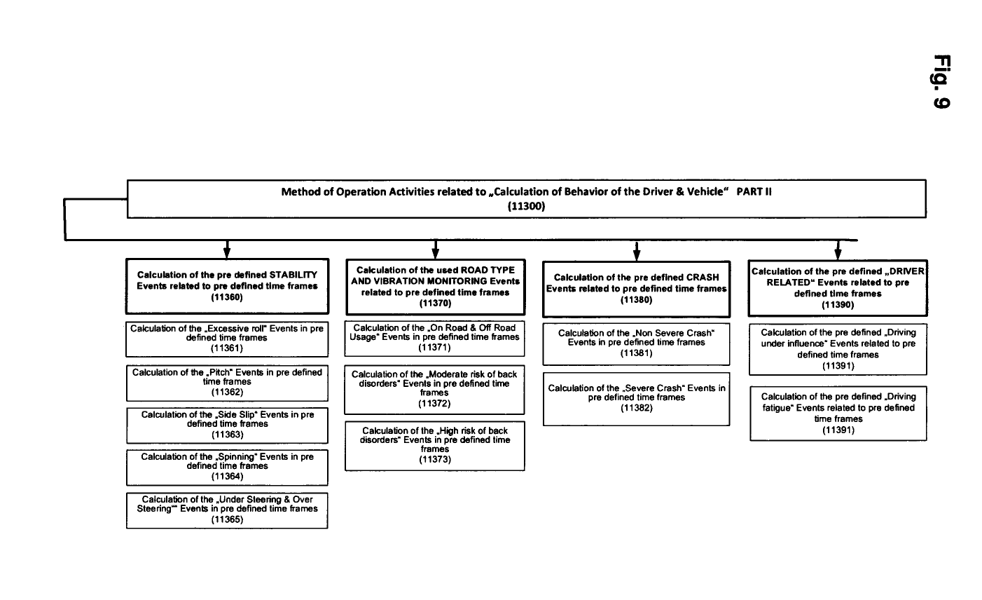

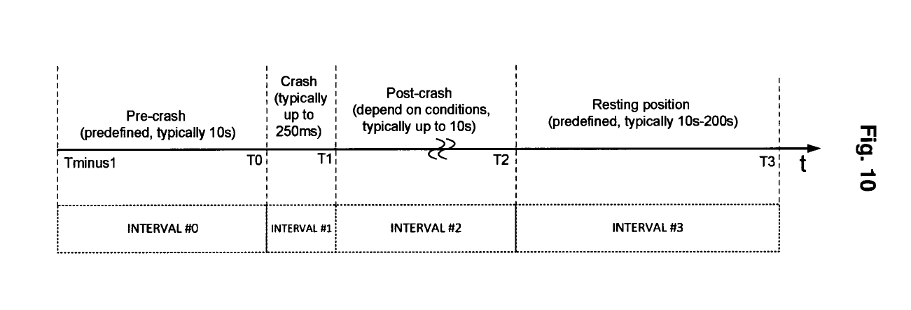

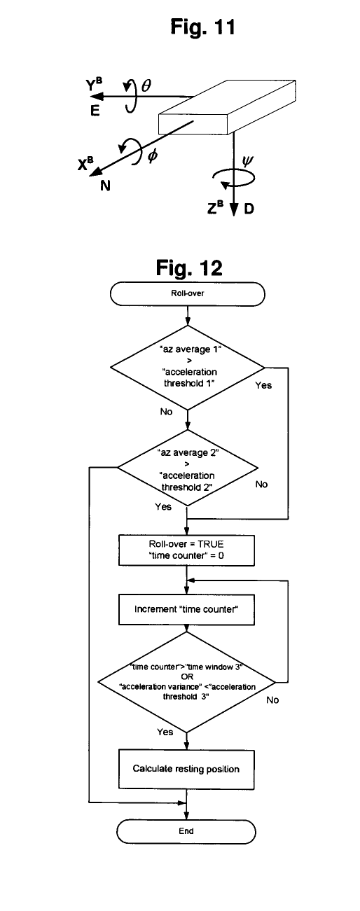

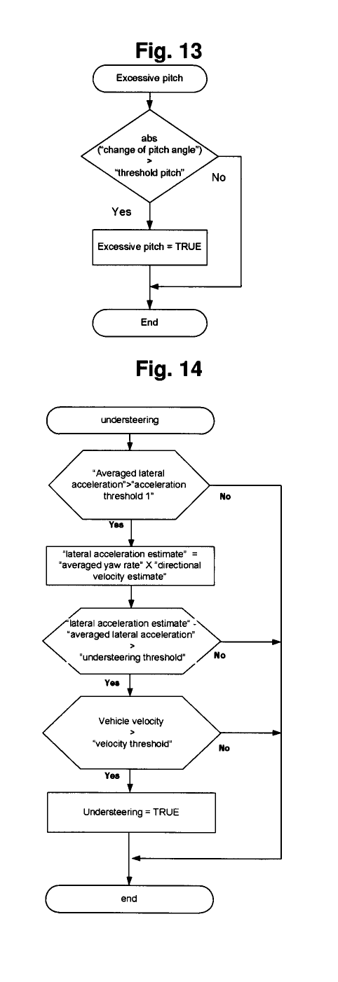

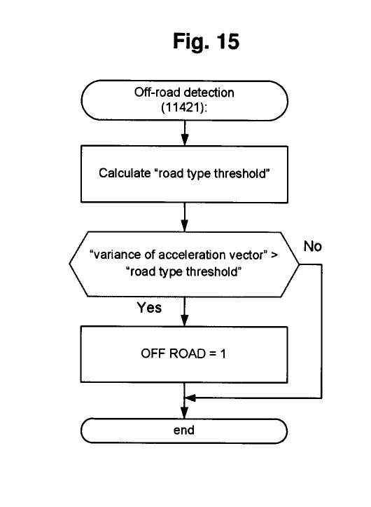

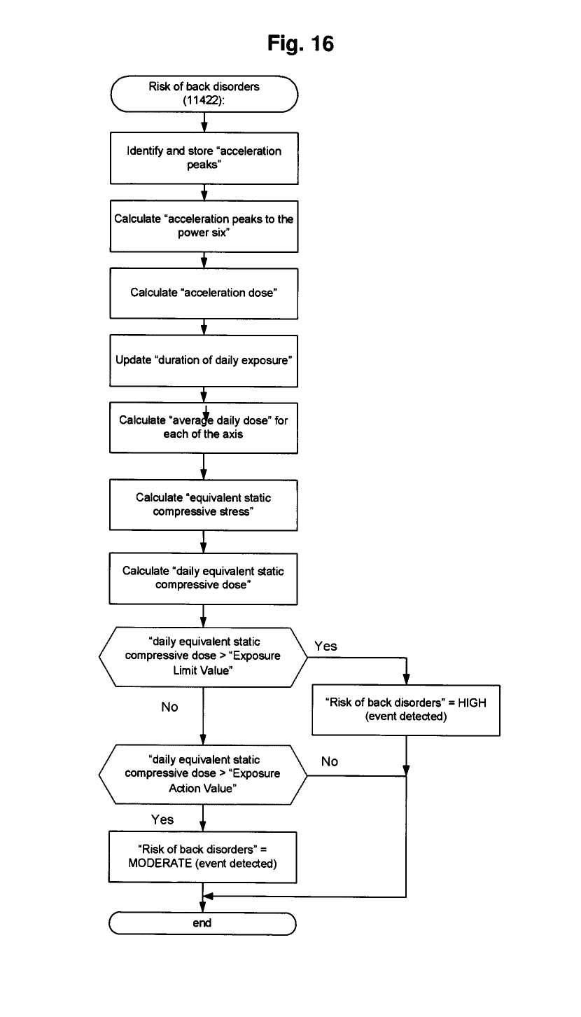

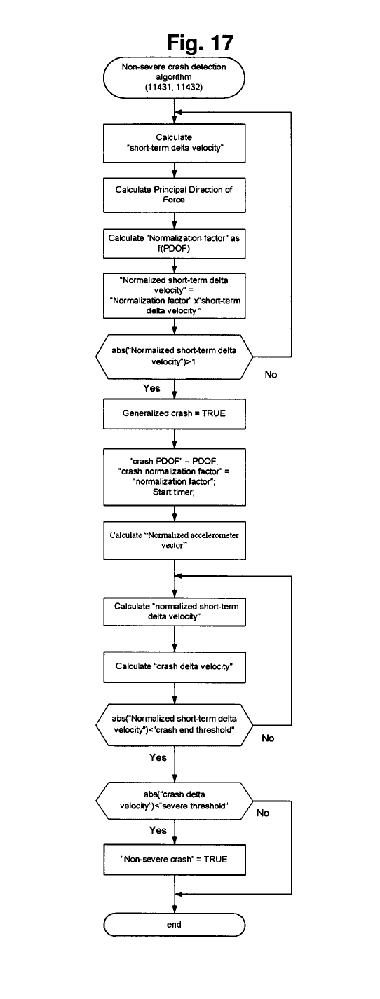

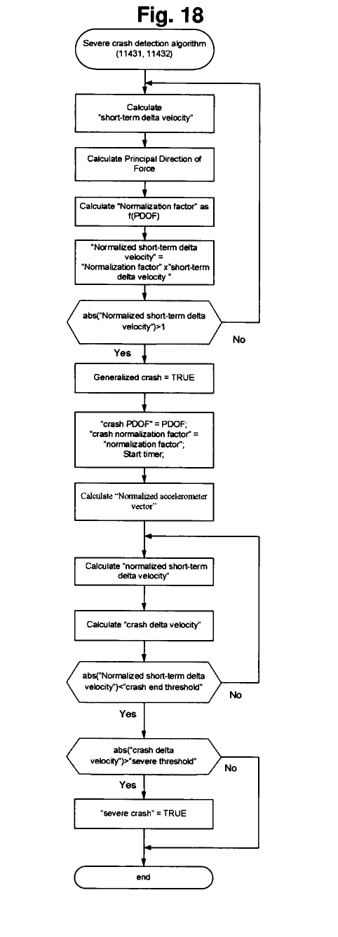

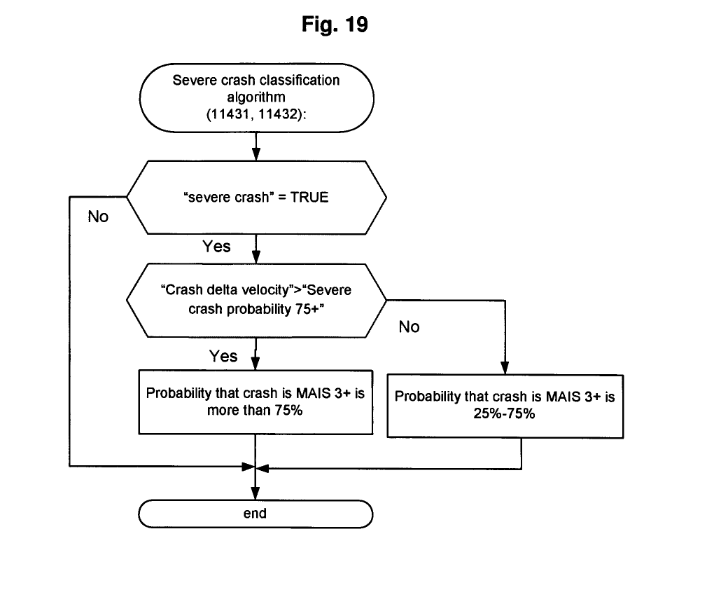

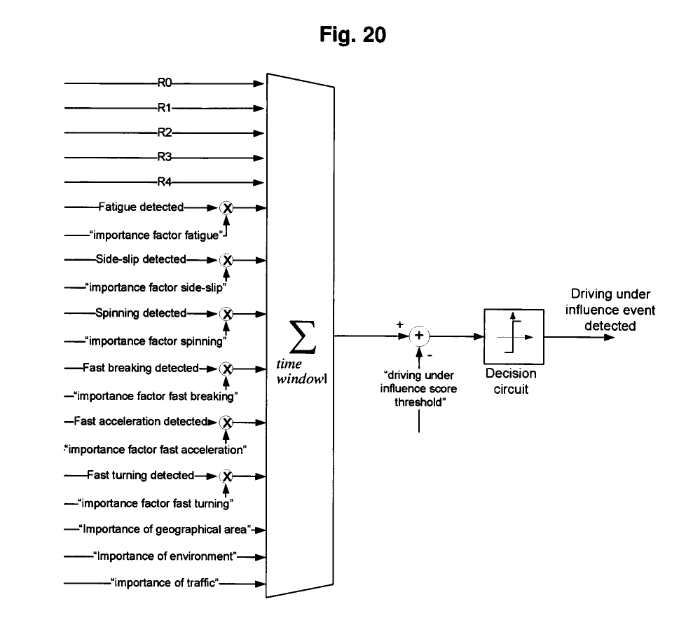

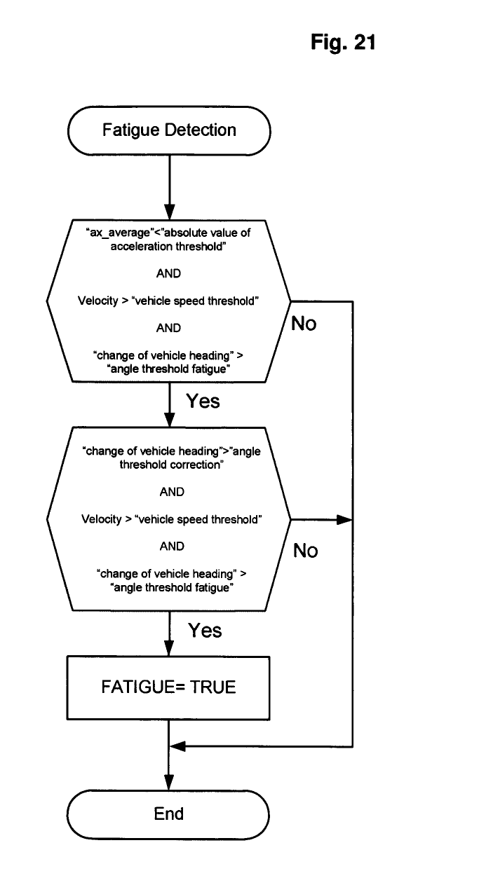

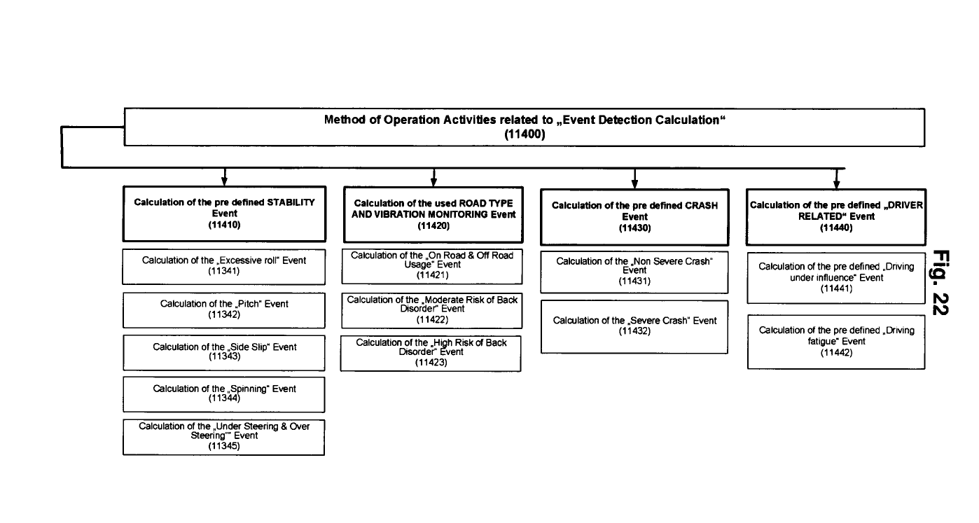

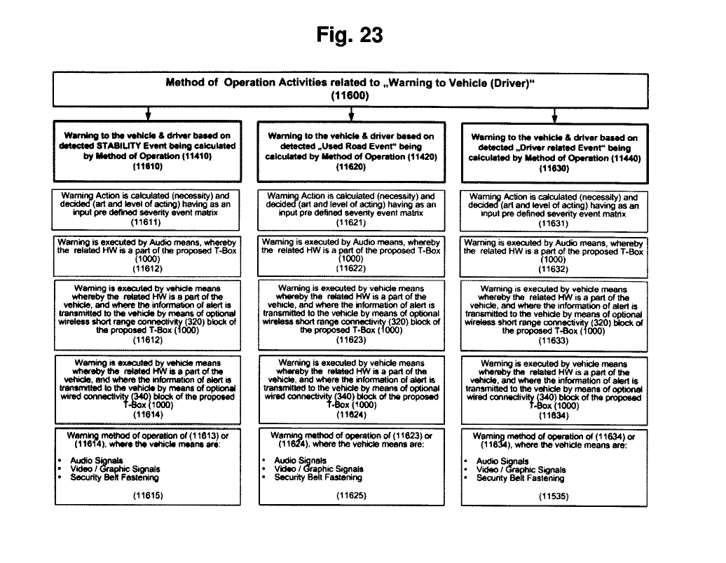

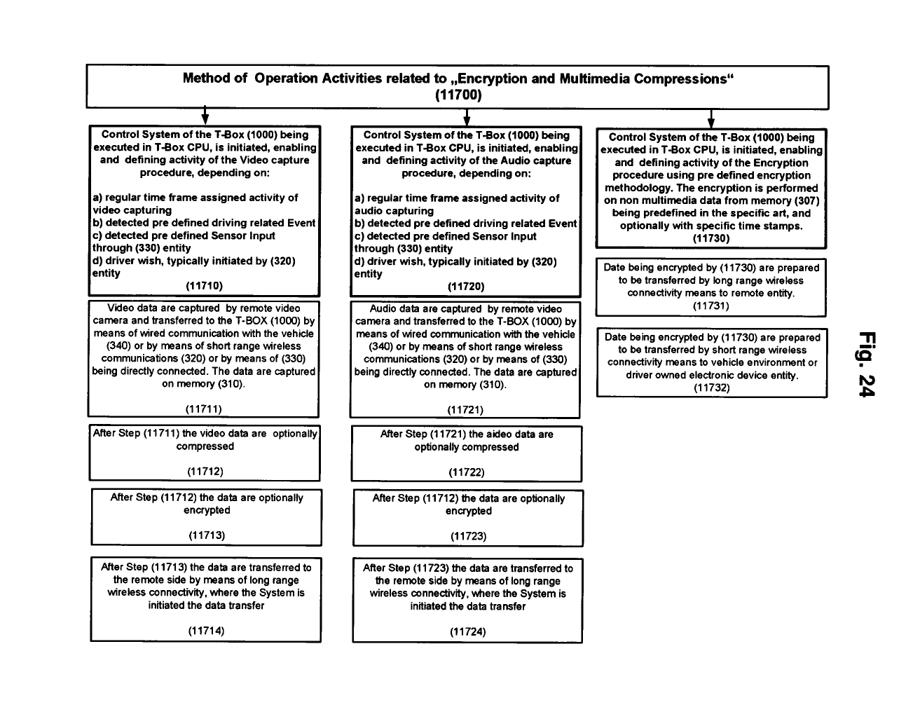

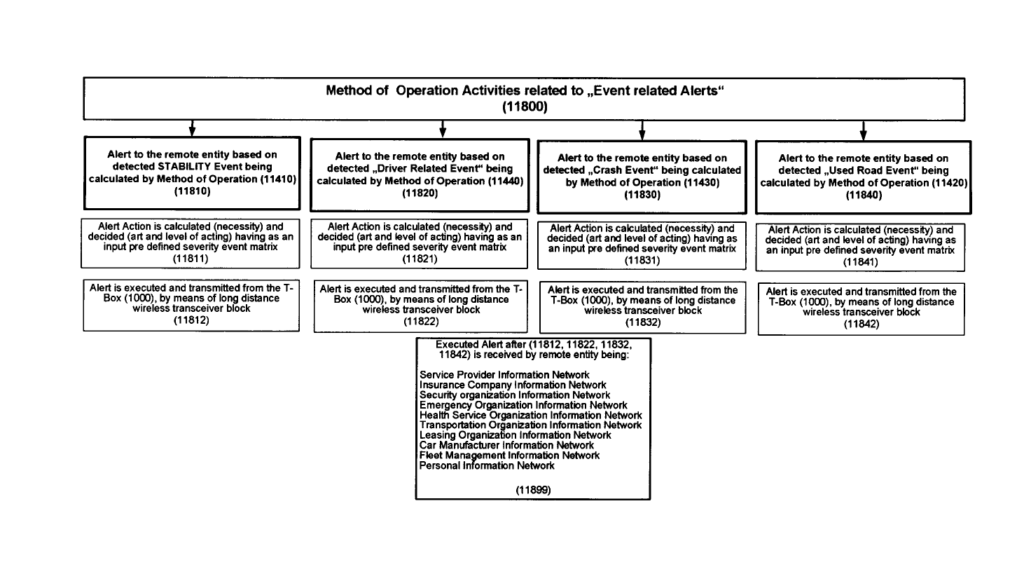

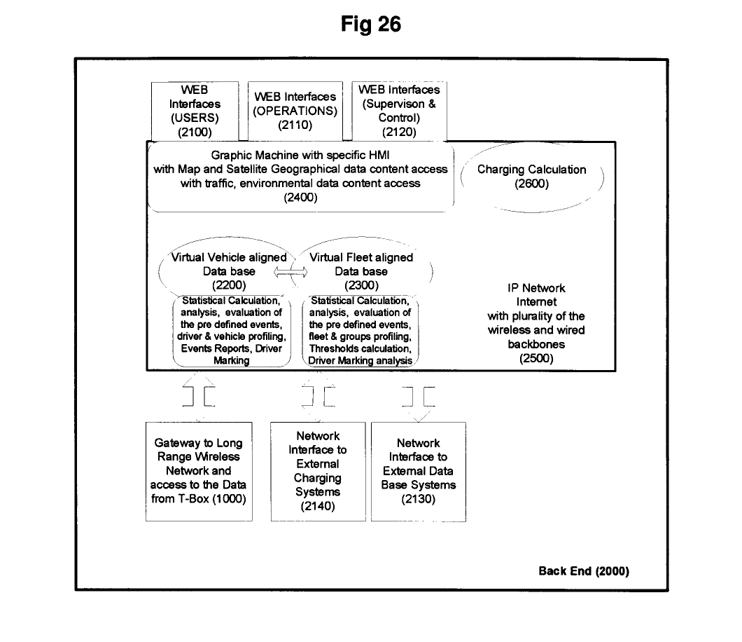

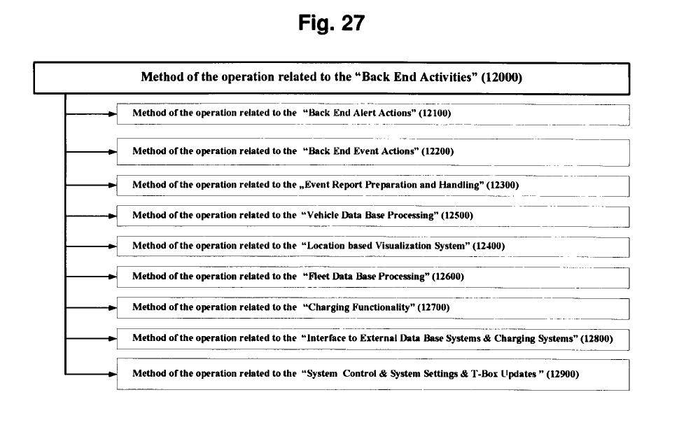

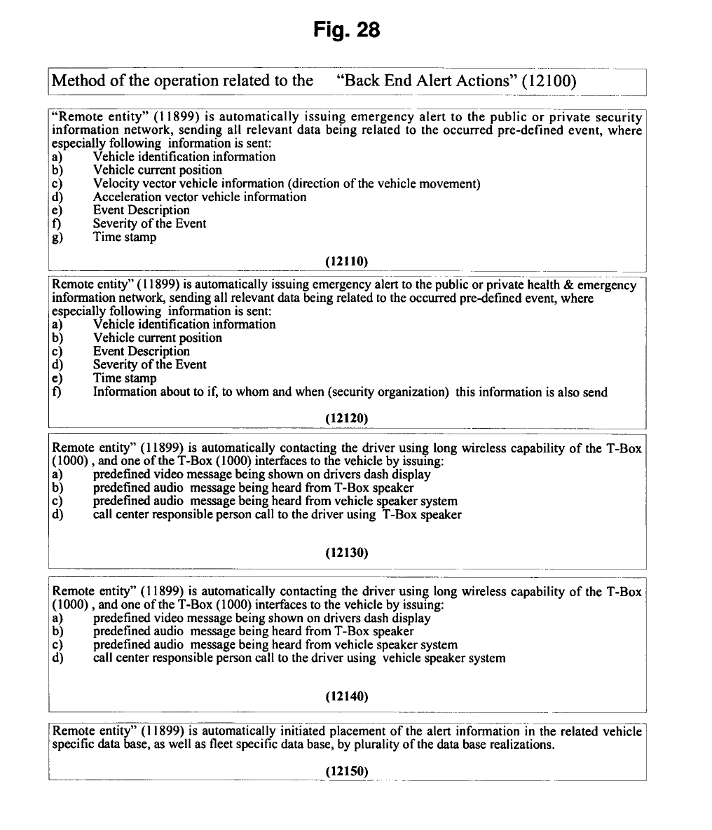

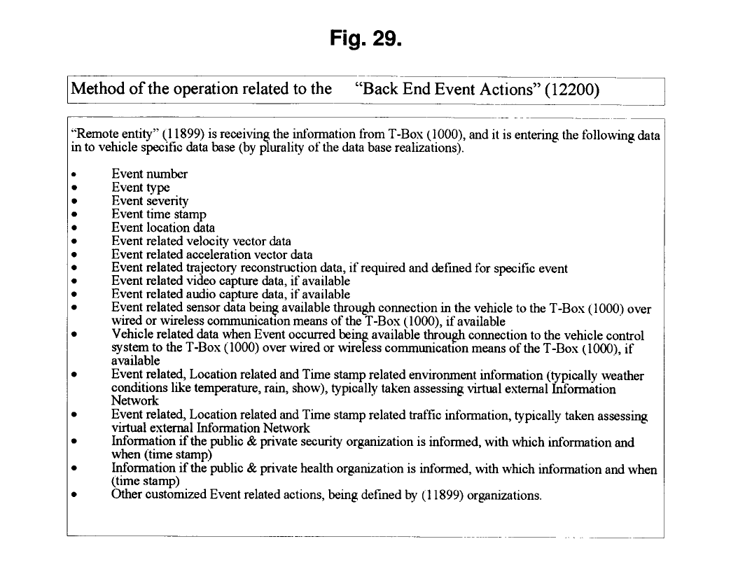

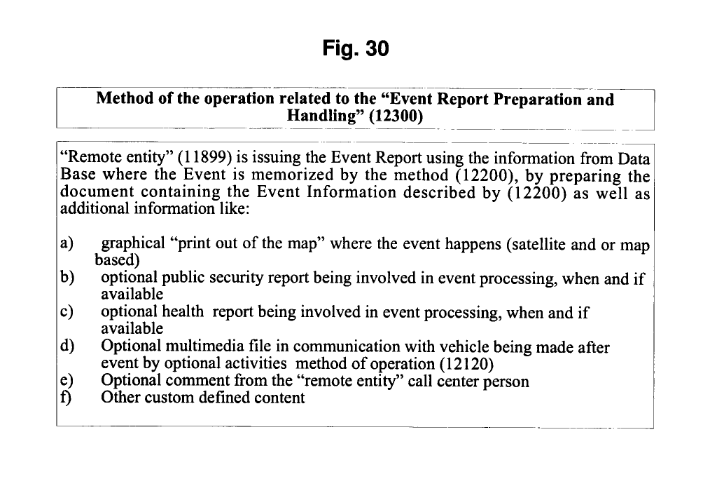

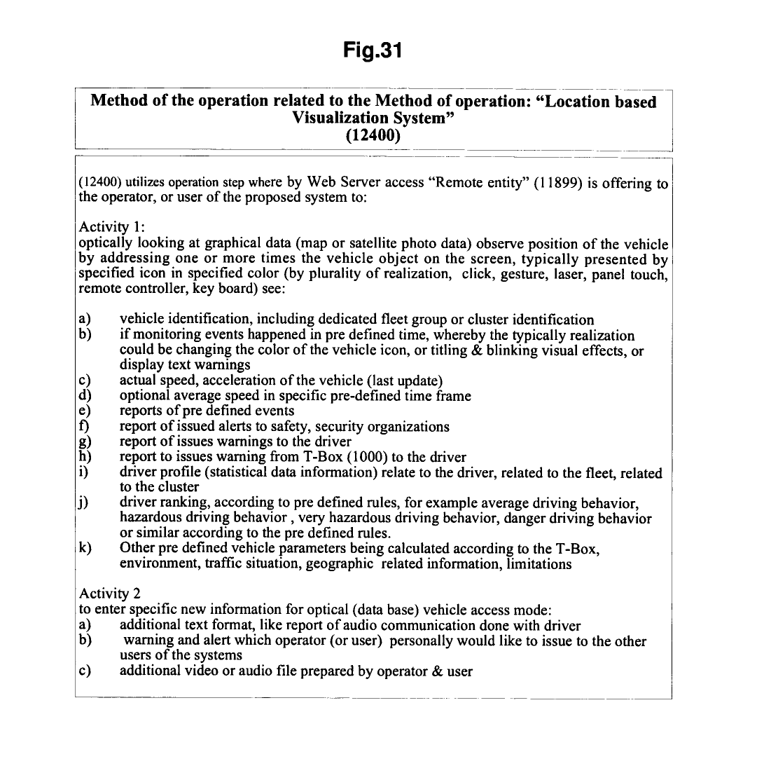

The proposed Telematics System Method of Operation (10000) described in the FIG. 4 relates to the set of activities being executed on the proposed T-Box (1000) and the set of activities which are not executed on the proposed T-Box (1000) but rather on the Back End SW, like presented in the FIG. 4. The portions of the activities from the proposed Telematics System Method of Operation (10000) related to the execution on T-Box (1000) are explained in detail in FIG. 5. Related Processor & Control Unit (130) as well as Memory (310) are the major HW blocks of the proposed T-Box (100), which are executing specific activities as a subset of all activities embodied in the proposed Telematics System Method of Operation (10000). Input information and description of the activities are presented in a structured way.

Following input data are provided to the execution HW units (130 and 310) of the T-box (1000), in order to execute the related subset of the Telematics System Method of Operation (10000), defined as (11000) subset of activities:
Provision of the Location Data from Satellite Positioning Systems, typically provided by the functional Unit (110)
Provision of Inertial Unit Data (Acceleration, Speed vectors) typically provided by the functional Unit (210 and 220)
Provision of Optional Data from Vehicle System where T-Box (1000) is mounted typically provided by the functional Unit (340)
Provision of Optional Data such as additional Sensors (Environment, Accessories) typically provided by the functional Unit (330)
Provision of Control Data (Settings, Orders) typically provided by the functional Unit (2000, Back End)
Provision of Maintenance and Upgrade Data typically provided by the functional Unit (2000, Back End)

Following Operations (11000) are executed in the T-Box (1000), particularly in functionalities (130) and (310), as a subset of the overall proposed Method of Operation (10000):
Calculation of Real Time Position Data (11100)
Calculation of Real Time Vector Trajectory of the Vehicle (11200)
Calculation of Behavior of the Driver & Vehicle (11300)
Calculation of Event Detection (11400)
Calculation of Vector Trajectory of the Vehicle after event occurrence (11500)
Optional Calculation of Pre-Event Warning to Vehicle System (Driver) (11600)
Optional Realization of Encryption and Multimedia Compressions (11700)
Optional Initialization of Event related Alerts (11800)

Method of Operation activity (11100): “Calculation of the Real Time Positioning Data” consists of two sub-activities: (11110) and (11120). Activity (11110) is calculation of the position using information from the navigation solutions, using global satellite navigation systems (by the plurality of available global satellite navigation systems), whereby the position information is provided in predefined time increments, typically specified and fixed by chip manufactures. In the activity (11120) calculation of the real time position is performed by using latest position fixes of the position data provided by (11110) and information from the 3D accelerators and gyroscope units being and the associated real time processing, whereby the provision of the calculated real time position data is typically shorter than the time increment between two position information deliveries (11110). This permits to get the position more precisely between two GNSS fixes or to get the position in the case of the GNSS outage. The calculation of the position is provided by so called “dead reckoning” algorithm.

Method of operation activity “Calculation of Real Time Vector Trajectory of the Vehicle” consists of two sub-activities: (11210) and (11220). In the activity (11210) synchronization of the vehicle vector velocity and acceleration data with real time position data obtained from Method of Operation (11120) and with respect to “real time” time stamp is performed. The buffering of the data or the data exchanges are performed in the T-Box memory, where the synchronization is physically taking place between two time increments. The time increment is time step being used for “real time” position calculation as in sub-method (11120). In the activity (11220) Calculation of “Real Time” Vehicle Vector velocity and acceleration information, being undertaken by the method (11210) and provision of the information through long distance wireless transceiver (120) is performed. Optionally this information is also provided to the short distance wireless transceiver (320) and optionally to the wired communication interface of the vehicle (340).

Method of Operation (11300): “Calculation of Statistical Behavior of the Driver & Vehicle” is described in detail in 9 different parts of activities denoted with numbers (11310, 11320 to 11390).

(11310) Calculation of the scalar velocity information in pre defined time periods. In the scope of this activity within Method of Operation a profile of the vehicle average speed may be provided. This information may be advantageously used for the risk estimation required by vehicle insurance companies by profiling the drivers for the security and safety relevant application scenarios. This procedure may be configured to average information calculus of the scalar velocity information in pre-defined time periods within a specific geographical area denoted by (11311). This information can be further used for traffic management purposes in the “pay HOW you drive” manner, meaning that if an average speed in the dedicated geographical area is larger than “pay per speed limit” the driver may be charged higher. In the same time if the driver is driving in a specific area close to the speed limit or above, the additional fees may be issued or an insurance company may rank the driver profile as one with higher risk. The state of the art solutions are typically offering features “pay per entry and per stay” within a specific geographical area. Method of Operation feature (11312) disclosed averaging information calculation of the scalar velocity information in pre defined time periods under specific environment conditions. This method of operation offers information important for profiling the driver behavior in cases of environmental conditions like cases of snow, rain or strong wind. If the driver is inherently driving faster on the average in a snow area or faster as median of other drivers, his exposure to the risk of an accident is higher. This information may be used for profiling and risk optimization of the insurance or it can become a “pre defined event” upon occurrence of which a driver warning or an alert to the “outside of the vehicle” information network could be issued. Method of Operation feature (11133) uses the averaging calculation of the scalar velocity information in pre defined time periods under specific traffic conditions, like higher speed in rush hours. This calculus may be important for the driver profiling of for risk optimizations by an insurance company. Method of operation (11314) considers combination of at least two method of operation options (11311, 11312 and 11313), where for example the driver is profiled if he is in a specific geographical area in the case of the rain and traffic jams and is driving faster than an average driver in the observed case. This may increase the probability of an accident and may be used for warnings to the driver or police, for driver negative profiling towards an insurance company or increased fee for using highways in a specific case.

(11320) Calculation of the scalar acceleration information in pre defined time periods. In the scope of this activity within the method of operation a profile of the vehicle average acceleration may be provided. This information may be advantageously used for the risk calculation by vehicle insurance companies, for profiling of drivers for security and safety relevant application scenarios. This procedure may be allocated to averaging information calculation of the scalar acceleration information in pre defined time periods under specific geographical area denoted by (11321). This information can be directly used for traffic management activity in the “pay HOW you drive” manner, meaning that if the average acceleration in the dedicated geographical area is larger than “pay per acceleration limit” the driver may be charged more. On the other hand if the driver is driving in a specific area in a very harsh way, with high accelerations an insurance company may rank the driver profile as more risky. Method of operation feature (11322) uses averaging information calculation of the scalar acceleration in pre defined time periods under specific environmental conditions. This method of operation offers information important for profiling the driver behavior in case of different environmental situations like the case of snow, rain or strong wind. If the driver is inherently driving with strong braking and high acceleration values on the average when compared to a median of other drivers, his exposure to the risk of an accident is higher. This information may be used for profiling and risk optimization by an insurance company or it can be defined as a “pre defined event” in order to issue driver warning alerts to the “outside of the vehicle” information network. Method of operation feature (11323) use averaging information calculation of the scalar acceleration in pre defined time periods under specific traffic conditions, like higher acceleration in the rush hours or in a case of traffic jams. This may be important for driver profiling and for risk optimization by insurance companies. Method of operation (11324) considers a combination of at least two method of operation options (11321, 11322 and 11323), where for example the driver is profiled if is in the a specific geographical area in the case of rain or traffic jams, and the acceleration of a driven vehicle is on average higher than a value in a referent model. This may increase the probability of an accident and can be used for warnings to the driver, to police, or for driver negative profiling with an insurance company, or for increased fee for using highways in a specific case.

(11330) Calculation of the velocity vector changes information in pre defined time periods. In the scope of this activity within method of operation a profile of changes of the vehicle velocity vector can be calculated. This information may be advantageously used for the risk estimation by insurance companies or for profiling of drivers for security and safety relevant application scenarios. This procedure may be allocated to calculation of the velocity vector changes in pre defined time periods under specific geographical area denoted by (11331). This information can be directly used for traffic management application, safety, security and health impact application scenarios. For example if a driver is changing direction of movement while driving for many times during a specific time period within a region where he should drive straight, specific events for detection can be defined and fleet management system may issue related warnings or talk to the driver, or remotely issue an “engine off” command. This event may for example be a possible indication of a fatigue status of a driver or a similar status. Method of operation feature (11332) uses calculation of the changes of the velocity vector in pre defined time periods under specific environmental conditions. Method of operation feature (11333) discloses calculation of the velocity vector changes in pre defined time periods under specific traffic conditions, like passing from one highway line to another in the rush hours or in case of traffic jams. These may be important for the driver profiling and risk optimization by an insurance company. Method of operation (11334) considers combination of at least two method of operation options (11331, 11332 and 11333), where for example the driver is profiled if in a specific geographical area, in the case of rain or traffic jams, crossing from one line to another, which may increase the probability of an accident and may be used for warnings to the driver, to police, or for driver negative profiling by an insurance company, or for increase of a fee for using highways in a specific case.

(11340) Calculation of the changes of the acceleration vector in pre defined time periods. In the scope of this activity within method of operation a profile of the changes of the vehicle acceleration vector is provided. This information may be advantageously used for the risk calculation by insurance companies, for profiling of the drivers or for the security and safety relevant application scenarios. This procedure may be allocated to calculation of the changes of the acceleration vector in pre defined time periods within a specific geographical area denoted by (11341). This information can be directly used for traffic management application, safety and security and for health impact application scenarios. For example, if the driver is changing the direction of driving for many times during a time period within a region, while using strong braking and high values of acceleration where he should drive straight without acceleration, specific events for tracking may be defined and fleet management system may issue related warnings, or talk to the driver, or remotely execute the “engine off” command. This event may, for example, be a possible indication of the driver fatigue status or similar. Method of operation feature (11342) uses calculation of the changes of the acceleration vector in pre defined time periods under specific environmental conditions. Method of operation feature (11343) uses calculation of the changes of acceleration vector in pre defined time periods under specific traffic condition, like passing from one highway line to another in the rush hours with strong accelerations. These may be important for the driver profiling and risk optimization by an insurance company. Method of operation (11344) considers a combination of at least two method of operation options (11341, 11342 and 11343), where for example the driver is profiled, if in a specific geographical area, in the case of rain or traffic jams, while crossing from one line to another, using strong accelerations and braking which may increase the probability of an accident. This information may be used for warnings to the driver, to police, for driver negative profiling by an insurance company, or for increase of a fee for using highways in a specific case.

Driving hours per pre defined time frame, (11350) is described as a Method operation. In the scope of this activity within method of operation a profile of driver behavior may be provided and easily used. Driving hours in a specific geographical area per pre defined time frame (11351) is can be derived as a specific instance of (11350). This feature of the proposed method of operation offers application scenarios like vehicle is paying the fee for staying during specified average time within a specific area. This may allow for example to “charge per average duration” being spent in a city center, or for charges for accessing large parking slots assigned for specific organizations. Method of operation feature (11352) considers driving hours in specified daily time slots per pre defined time frame. This may allow for higher charges due to spending time driving in a city center during mornings or discounts during early afternoons as a simple application of the proposed solution. Driving hours in specified daily time slots per pre defined time frame under specific environmental conditions method of operation feature (11353), allows an application of profiling driver behavior during winter periods with increased accident risk factors. Driving duration per pre defined time frame in specified traffic conditions (11354) is a method of operation feature exploiting driving habits such as spending a lots of time in the traffic jams, which may be used to offer additional comfort services. Driving duration per pre defined time frame in specific traffic conditions, during specific environmental conditions, in specified time slots and/or within a specific geographical area is a method of operation option (11355) comprising combination of at least two method of operation options (11351, 11352, 11353, 11354). Proposed combined method of operation may be advantageously used for the risk calculation by insurance companies, for profiling of drivers or for the security and safety relevant application scenarios.

Method of Operation Activity (11360) may be executed in such a way that in pre defined time frames and within pre defined geographical area a statistics of specific pre defined “Stability” events are calculated. Calculation of the pre defined STABILITY Events related to pre defined time frames (11360) may be broken down into a set of statistically processed stability events:
Calculation of the “Excessive roll” Events during pre defined time frames (11361)
Calculation of the “Pitch” Events during pre defined time frames (11362)
Calculation of the “Side Slip” Events during pre defined time frames (11363)
Calculation of the “Spinning” Events during pre defined time frames (11364)
Calculation of the “Under Steering & Over Steering” Events during pre defined time frames (11365)

Stability events may be advantageously used for profiling the driver behavior relative to adaptation of the driver to the environment. This may measure the aggressive type driving or potential danger to other vehicles, passengers or trailer, in which T-Box is installed. These events in reality may appear before an occurrence of a Crash event. They may suitable to generate alerts, pre crash warning and general warning to the IT network outside of the vehicle. Proposed System with Method of operations inherently allows a detection of the Stability events.

Calculation of the used ROAD TYPE AND VIBRATION MONITORING Events related during pre defined time frames (11370) comprises following typical events:
Calculation of the “On Road & Off Road Vehicle Usage” Events during pre defined time frames (11371)
Calculation of the “Moderate risk of back disorders” Events during pre defined time frames (11372)
Calculation of the “High risk of back disorders” Events during pre defined time frames (11373)

Statistical information regarding Road Type Events, for example, percentage of usage on or off road during pre-defined time periods is important information for driver behavior from risk of insurance perspective. If during a short observation period a lot of on road and off road events changing occur, there is a probability that the driver is not driving correctly or that the driver is under influence or tired, which means that warnings may be issued or security organizations would need to be informed in order to check the situation.

Method of operation features “Moderate risk of back disorders”(11372) and “High risk of back disorders”(11373) determine a level of physical stress due to whole-body vibrations. It is one of the standardized ways to quantify a whole-body vibration level and the derived health risk. Terms used in calculations are defined as following:
The acceleration dose and the daily acceleration dose are used to determine if a vehicle operator is exposed to a dangerous level of vibrations that can affect his health. The acceleration Dose calculation is defined in ISO 2631-5 (2004) and in EU Directive 2002/44/EC, 2002. The EU Directive 2002/44/EC, 2002 stipulates minimal standards for health and safety of workers exposed to whole-body vibrations.
The Daily Equivalent Static compressive dose quantifies potential health effects and might be used for their assessment or for developing a warning system that would indicate a health risk. Calculation of the Daily Equivalent Static compressive dose is further defined in ISO 2631-5 (2004) and in EU Directive 2002/44/EC, 2002. The EU Directive 2002/44/EC, 2002 stipulates minimum standards for health and safety of workers exposed to whole-body vibrations.

If Daily Equivalent Static compressive dose is below a defined Exposure Action Value (EAV) the probability of an adverse health effect is low. If acceleration dose exceeds defined Exposure Limit Value (ELV) there is a high probability of an adverse health effect and a high risk of a back disorder.

Calculation of the pre defined CRASH Events during pre defined time frames (11430) considers:
Calculation of “Non Severe Crash” Events during pre defined time frames (11431)
Calculation of “Severe Crash” Events during pre defined time frames (11432)

Statistical information related to Crash Events, especially ones like “Non Severe Crash”, is valuable information for insurance directly influencing the damage risk related to a particular driver.
Method of operation feature “Non Severe Crash”(11431) is based on monitoring of a change of the velocity vector during short-term window. The acceleration vector is continuously integrated over a predefined time-window. In parallel, the algorithm calculates a principal direction of force (PDOF) in the horizontal and vertical planes. PDOF determines a value of normalization factor, which is used to normalize this change of the velocity vector. At the moment when this normalized change of the velocity vector exceeds a threshold pre-set to number 1 (as all inputs were normalized) a general crash is detected and the calculated PDOF is recorded as a “crash PDOF”. This triggers a process of accumulation of the changes of velocity vector along with a start of a timer to determine the crash duration. A short-term integration of the acceleration vector is continued until it falls below a predefined crash-end threshold that marks an end of the crash event. If the cumulative change of the velocity vector during the crash interval is below a threshold defined for severe-crash events, this crash is automatically considered as a non-severe. If the device detects multiple crashes or a crash with a roll-over or there is another indication of an entrapment of passengers, the final change of speed is increased and re-compared to the threshold.

Method of operation feature “Severe Crash”(11432) is based on monitoring of the change of the velocity vector during short-term window. The acceleration vector is continuously integrated over a predefined time-window. In parallel, the algorithm calculates the principal direction of force (PDOF) in the horizontal and vertical planes. PDOF determines the value of normalization factor, which is used to normalize this change of the velocity vector. At a moment when this normalized change of the velocity vector exceeds a threshold pre-set to number 1 (as all inputs were normalized) a general crash is detected and the calculated PDOF is recorded as a “crash PDOF”. This triggers the process of accumulation of change of velocity vector along with a start of timer to determine the crash duration. A short-term integration of the acceleration vector is continued until it falls below a predefined crash-end threshold that marks an end of the crash event. If the cumulative change of the velocity vector during the crash interval is above a threshold defined for severe-crash events, this crash is automatically considered as severe. If the device detects multiple crashes or a crash with roll-over or there is another indication of an entrapment of passengers, a final change of speed is increased and re-compared to the threshold. After this, an additional stratification is performed to medium (25-75%) and high (>75%) probability of severe crash.

Calculation of the pre defined “DRIVER RELATED” Events during pre defined time frames (11390) considers:
Calculation of pre defined “Driving under influence” Events during pre defined time frames (11391)
Calculation of pre defined “Driving fatigue” Events during defined time frames (11391)

Statistical information related to “Driving under the Influence” Events, and “Driving fatigue” Events during a specific pre-defined time, are valuable information for driver safety, public security as well as for the insurance, directly influencing the damage risk related to a particular driver. An essential advantage of the proposed system is an ability to recognize, detect, evaluate and calculate the statistics of these events.

Method of Operation Activities related to “Warning to Vehicle (Driver)” (11600), are features which offer additional information to a driver, on the one side, directly enhancing the safety of a driver and, on the other side, may reduce the probability of an accident. The 3D inertial sensors in the T-Box (1000) with the related processing may use the detection of the pre defined events (11400) to issue a pre-crash warning or different kind of warnings to a driver. Based on different types of the detected event classes of the Method of operation different activities (11610-11630) are derived.
Method of Operation activity (11610) is comprising Warning to the vehicle & driver based on the detected STABILITY Event calculated by Method of Operation (11410). Method of Operation activity (11620) is comprising Warning to the vehicle & driver based on the detected “Used Road Event” calculated by Method of Operation (11420).

Method of Operation activity (11630) is comprising Warning to the vehicle & driver based on detected “Driver related Event” being calculated by Method of Operation (11440).

Warning Action is calculated (necessity) and decided (art and level of acting) having as an input a pre defined severity event matrix. A warning may be executed by Audio means, whereby the related HW is a part of the proposed T-Box (1000). Warning may be executed by vehicle means, whereby the related HW is a part of the vehicle and where the information of alert is transmitted to the vehicle by means of optional wireless short range connectivity (320) block of the proposed T-Box (1000). Warning may be executed by vehicle means whereby the related HW is a part of the vehicle and where the information of alert is transmitted to the vehicle by means of optional wired connectivity (340) block of the proposed T-Box (1000). Warning method of operation may be executed by vehicle means such as:
Audio Signals
Video/Graphic Signals
Security Belt Fastening

Above described Method (11600) may be related to the Events that have already happened, as described, but may be advantageously used as pre-warning, addressing potential events which may happen in the future. The calculation of those potential future events is done by using a specific data processing approach, being performed in the T-Box (1000), where environmental related information and driver specific related information are also typically used for the calculation of the potential future event in the scope of the Method of operation activity (11400).

Method of Operation Activities related to “Encryption and Multimedia Compressions” (11700) are proposed, comprising video capture related activities, audio capture related activities and pure encryption activities related to non multimedia data.

Video Capture activities are defined in (11710, 11711, 11712, 11713, 11714) action steps. Method of Operation Step (11710) is defined as:
Control System of the T-Box (1000) being executed in T-Box CPU, is initiating, enabling and defining activity of the Video capture procedure, depending on:
a) a regular time frame assigned activity for video tape
b) a detected pre defined driving related Event
c) a detected pre defined Sensor Input through (330) entity
d) a driver wish, typically initiated by (320) entity

Method of Operation Step (11711) is defined as:
Video data is captured by a remote video camera and transferred to the T-BOX (1000) by means of wired communication with the vehicle (340) or by means of short range wireless communications (320) or by means of (330) being directly connected. The data is captured and stored in memory (310).

Method of Operation Step (11712) is defined as:
After Step (11711) the video data is optionally compressed. The compression is typically provided by the plurality of the realization in MPEG 2/4/10 or in MJPEG or is provided as compressed by a camera.

Method of Operation Step (11713) is defined as:
After Step (11712) the data is optionally encrypted. Plurality of the encryption methods and bit compression deepness may be utilized. Advantageously AES encryption with 16 bits is proposed.

Method of Operation Step (11714) is defined as:
After Step (11713) the data is transferred to the remote side by means of long range wireless connectivity, wherein the System has initiated the data transfer

Audio Capture activities are defined in (11720, 11721, 11722, 11723, 11724) action steps. Method of Operation Step (11720) is defined as:
Control System of the T-Box (1000) being executed in T-Box CPU, is initiating, enabling and defining activity of the Audio capture procedure, depending on:
a) a regular time frame assigned activity of audio capture
b) a detected pre defined driving related Event
c) a detected pre defined Sensor Input through (330) entity
d) a driver wish, typically initiated by (320) entity

Method of Operation Step (11721) is defined as:
Audio data is captured by a remote video camera and transferred to the T-BOX (1000) by means of wired communication within the vehicle (340) or by means of short range wireless communications (320) or by means of (330) being directly connected. The data is captured in memory (310).

Method of Operation Step (11722) is defined as:
After Step (11721) the audio data is optionally compressed. The compressing is typically executed, by the plurality of the audio codecs like: speech codecs, Polycom codecs, AAC family codecs, MP3 codec, CELP codecs or is as compressed provided from the microphone entity.

Method of Operation Step (11723) is defined as:
After Step (11722) the data is optionally encrypted. Plurality of the encryption methods and bit compression deepness may be utilized. Typically AES encryption with 16 bits is proposed.

Method of Operation Step (11724) is defined as:
After Step (11723) the data is transferred to the remote side by means of long range wireless connectivity, where the System is initiating the data transfer

Method of Operation Step (11730) is defined as:
Control System of the T-Box (1000) being executed in T-Box CPU, is initiating, enabling and defining an activity of the Encryption procedure using a pre defined encryption methodology. The encryption is performed on non multimedia data from the memory (307) being predefined in the specific art, and optionally with specific time stamps.

Method of Operation Step (11731) is defined as:
Date being encrypted by (11730) is prepared to be transferred by long range wireless connectivity means to a remote entity.

Method of Operation Step (11732) is defined as:
Date being encrypted by (11730) is prepared to be transferred by short range wireless connectivity means to a vehicle environment or to a driver owned electronic device entity.

Method of Operation Activities related to “Event related Alerts” (11800) comprises activities related to actions for caused by different art of occurred events described in (11810, 11820 and 11830). It relates to the alerts which are sent “out of the vehicle” world.

Method of Operation Step (11810) is defined as:
Alert to a remote entity based on detected STABILITY Event being calculated by Method of Operation (11410)

Method of Operation Step (11811) is defined as:
Alert Action is calculated (necessity) and decided (art and level of acting) having as an input a pre defined severity event matrix. In the scope of the pre defined action rules, a choice of the stability events, which would be needed to be communicated in the case of occurrence, is defined. After detection of an event which is classified as an event to cause a remote alert, the severity of the event is checked. A pre defined severity matrix for related event is stored in the memory of T -Box (1000). In the description of the predefined Events a specific set of the thresholds for specific events is defined. If the values for dedicated thresholds are achieved, the pre requisites to issue alerts are met. The complete proposed System has proposed features on regular updates of the firmware through the wireless long range network (typically cellular network). In the scope of these updates the severity matrix for pre-defined events may be changed allowing enabling and disenabling specific event alerts or changing the values of one or more thresholds.

Method of Operation Step (11812) is defined as:
Alert is executed and transmitted from the T-Box (1000) by means of long distance wireless transceiver block (120).

Method of Operation Step (11820) is defined as:
Alert to a remote entity based on a detected “DRIVER RELATED” Event being calculated by Method of Operation (11440). This method of operation offers a novel feature to inform “out of the vehicle” environment about an occurrence of the events like “driving under influence”, and “driving under fatigue”.

Method of Operation Step (11821) is defined as:
Alert Action is calculated (necessity) and decided (art and level of acting) having as an input a pre defined severity event matrix. In the scope of the pre defined action rules, a choice of the “driver related” events, which would be needed, in the case of occurrence, to be communicated, is defined. After detection of an event which is classified as an event to cause a remote alert, the severity of the event is checked. A pre defined severity matrix for related event is stored in the memory of T -Box (1000). In the description of the predefined Events a specific set of the thresholds for specific events is defined. If the values for dedicated thresholds are achieved, the pre requisites to issue alerts are met. In specific cases the definition of the event occurrence is checked by more than one methodology. The system may issue alerts according to occurrence of an event or at least one set of reached thresholds, or by system setting that more than one methodology of achieving the events and severity thresholds is required. In the process of the severity matrix check, the alert information for specific event detection, may be enriched with information like: how many pre defined thresholds are surpassed. This means that Alert may be for example: driver is like to be under influence of alcohol or drugs, and his event is marked with smaller danger, medium danger, large danger or similar grading mark. The complete proposed System has a proposed feature on regular updates of the firmware through the wireless long range network (typically a cellular network). In the scope of these updates, the severity matrix of pre-defined events may be changed, enabling and disenabling the specific event alerts or changing the values of one or more thresholds.

Method of Operation Step (11822) is defined as:
Alert is executed and transmitted from the T-Box (1000), by means of long distance wireless transceiver block.

Method of Operation Step (11830) is defined as:
Alert to a remote entity based on detected “CRASH” Event being calculated by Method of Operation (11430). This method of operation offers a novel feature to inform “out of the vehicle” environment about an occurrence of the “Crash” events, where “Crash” event may be also a “smaller” crash, where for example airbags are not activated, but the vehicle objectively may be damaged, and/or where a potential for significantly reduced safety of the driver (or other people and objects in traffic) may arise.

Method of Operation Step (11831) is defined as:
Alert Action is calculated (necessity) and decided (art and level of acting) having as an input a pre defined severity event matrix. In the scope of the pre defined action rules, a choice of the “crash” events, which would need, in a case of occurrence, to be communicated, is defined. After detection of the event which is classified as an event to cause a remote alert, the severity of the event is checked. A pre defined severity matrix for related event is stored in the memory of T-Box (1000). In the description of the predefined Events a specific set of the thresholds for specific events is defined. If the values for corresponding thresholds are achieved, the pre requisites to issue alerts are met. In specific cases the definition of an event occurrence is checked by more than one methodology. The system may issue the alerts according to an occurrence or at least one set of reached thresholds, or by system setting that more than one methodology of achieving the events and severity thresholds is required. In the process of the severity matrix check, the alert information of a specific event detection may be enriched with the information like how many thresholds are surpassed and/or what kind of forces were acting, including vector information. This means that alert may be that a small crash appeared, with the “smaller” severity, where the hit force of specific value was coming from the dedicated angle compared to the driver trajectory vector. The complete proposed System has a proposed feature of regular updates of the firmware through the wireless long range network (typically a cellular network). In the scope of these updates the severity matrix of pre-defined events may be changed, enabling and disenabling the specific event alerts or changing the values of one or more thresholds. This means, for example, if the driver continues to drive after “a small crash” has appeared, the “owner” of the system may decide to “observe” further behavior of the vehicle by changing thresholds in order to ensure some “more drastic” decisions, like alarming the police, or if the technical pre requisites are met (T-Box option) to stop the vehicle remotely.

Method of Operation Step (11832) is defined as:
Alert is executed and transmitted from the T-Box (1000), by means of a long distance wireless transceiver block.

Method of Operation Step (11840) is defined as:
Alerts to a remote entity based on detected “USED ROAD” Event being calculated by Method of Operation (11420). This method of operation offers a novel feature to inform “out of the vehicle” environment about an occurrence of the “USED ROAD” events. The “Used Road” events may be analyzed and monitored from the perspective of how often a vehicle is changing from off to on road. This can be further extended as potential methodology to detect with a certain probability that driving under fatigue, driving under the influence or driving under health problems has occurred.

Method of Operation Step (11841) is defined as:
Alert Action is calculated (necessity) and decided (art and level of acting) having as an input a pre defined severity event matrix. The severity of the event may be set in a way to issue an alert if the vehicle:
   is driving during the pre defined time frame more than a defined percentage of time off road,
   is changing during the pre defined time frame from off-road to on-road more than allowed by the system, or is crossing the middle lane border mark on the road more than allowed by the system. Pre requisite for the detection of the crossing of the lane mark is to have a specific lane marking that will cause a detection by inertial sensors of the T-Box (1000)
   is crossing the outer lane border mark of the road more than allowed by the system pre requisite to the fact that the crossing of the lane mark is causing a detection by inertial sensors of the T-Box (1000)

Method of Operation Step (11842) is defined as:
Alert is executed and transmitted from the T-Box (1000), by means of long distance wireless transceiver block.

Executed Alert after (11812, 11822, 11832, 11842) is received by a “remote entity” being typically defined as an activity (11899):
Service Provider Information Network
Insurance Company Information Network
Security Organization Information Network
Emergency Organization Information Network
Health Service Organization Information Network
Transportation Organization Information Network
Leasing Organization Information Network
Car Manufacturer Information Network
Fleet Management Information Network
Personal Information Network

The “remote entity” described in (11899) after “receiving” alerts from (11800) is in title to initialize actions, which are described as a “Back End Alert Actions” (12100), as a part of Method of operation related to the Back End (12000).

Method of the operation related to the “Back End Activities” (12000) comprises following Method of Operations Steps:
“Back End Alert Actions” (12100)
“Back End Event Actions” (12200)
“Event Report Preparation and Handling” (12300)
“Location based Visualization System” (12400)
“Vehicle Data Base Processing” (12500)
“Fleet Data Base Processing” (12600)
“Charging Functionality” (12700)
“Interface to External Data Base Systems & Charging Systems” (12800)
“System Control & System Settings & T-Box Updates ” (12900)

Method of operation: “Back End Alert Actions” (12100) comprises Method of Operations Steps (12110-12140).
Method of Operation Step (12110) is defined as:
“Remote entity” (11899) is automatically issuing an emergency alert to the public or private security information network, sending all relevant data related to the occurred pre-defined event, whereby especially following information is sent:
   a) Vehicle identification information
   b) Vehicle current position information
   c) Velocity vector vehicle information (a direction of the vehicle movement)
   d) Acceleration vector vehicle information
   e) An Event Description
   f) A Severity of the Event
   g) A Time stamp
Optionally, if the T-Box (1000) features are completely implemented, information set may be enriched with the following additional information, which may be prepared ready for public & private security organization (example is police, security organization in specific dedicated geographical area) like:
   a) video & audio capture data
   b) trajectory reconstruction in case of specifically occurred event
   c) information of the passengers health situation, if the passengers have health related sensor with short range wireless, which may access to the Black-Box short range wireless sensor

Method of Operation Step (12120) is defined as:
Remote entity” (11899) is automatically issuing an emergency alert to the public or private health & emergency information network, sending all relevant data being related to the occurred pre-defined event, whereby especially the following information is sent:
   a) Vehicle identification information
   b) Vehicle current position information
   c) An Event Description
   d) A Severity of the Event
   e) A Time stamp
   f) Information about to to whom and when (security organization) this information has been also sent
Optionally, if the T-Box (1000) features are completely implemented information set may be enriched with the following additional information, which may be prepared ready for public & private health & emergency organizations (example is a local emergency hospital . . . ) like:
   a) video & audio capture data
   b) information of the passengers health situation, if the passengers have health related sensors with short range wireless, which may access to the T-Box short range wireless sensor.

Method of Operation Step (12130) is defined as:
Remote entity” (11899) is automatically contacting the driver using long range wireless capability of the T-Box (1000) and one of the T-Box (1000) interfaces to the vehicle by issuing:
   a) a predefined video message being shown on the drivers dash display
   b) a predefined audio message being heard from a T-Box speaker
   c) a predefined audio message being heard from the vehicle speaker system
   d) a call center responsible person call to the driver using a T-Box speaker
   e) a call center responsible person call to the driver using a vehicle speaker system

Method of Operation Step (12140) is defined as:
“Remote entity” (11899) is automatically initiating a defined measure using long range wireless capability of the T-Box (1000) and one of the T-Box (1000) interfaces to the vehicle by issuing:
   a) a stop of the vehicle by turning off the motor, if this functionality is allowed by the T-Box installation, which typically would require a wired connectivity of the T-Box to the vehicle control system
   b) a slow down (velocity decrease) of the vehicle by motor turn off, if this functionality is allowed by the T-Box installation, which typically would require a wired connectivity of the T-Box to the vehicle control system
   c) decelerating (acceleration decrease) the vehicle by motor turn off, if this functionality is allowed by the T-Box installation, which typically would require a wired connectivity of the T-Box to the vehicle control system

Method of Operation Step (12150) is defined as:
“Remote entity” (11899) is automatically initiating a placement of an alert information in the related vehicle specific data base, as well as fleet specific data base, by plurality of the data base realizations.

Method of operation: “Back End Event Actions” (12200) is defined as:
“Remote entity” (11899) is receiving the information from T-Box (1000), and it is entering the following data into a vehicle specific data base (by plurality of the data base realizations):
   An Event number
   An Event type
   An Event severity
   An Event time stamp
   An Event location data
   An Event related velocity vector data
   An Event related acceleration vector data
   An Event related trajectory reconstruction data, if required and defined for a specific event
   An Event related video data capture, if available
   An Event related audio data capture, if available
   An Event related sensor data being available through a connection in the vehicle to the T-Box (1000) over wired or wireless communication means of the T-Box (1000), if available
   Vehicle related data when an Event occurred being available through a connection to the vehicle control system to the T-Box (1000) over wired or wireless communication means of the T-Box (1000), if available
   Event related, Location related and Time stamp related environment information (typically weather conditions like temperature, rain, show), typically taken by assessing virtual external Information Network
   Event related, Location related and Time stamp related traffic information, typically taken by assessing virtual external Information Network
   Information if the public & private security organization is informed, with which information and when (time stamp)
   Information if the public & private health organization is informed, with which information and when (time stamp)
   Other customized Event related actions, being defined by (11899) organizations.

Method of operation: “Event Report Preparation and Handling” (12300) is defined as “Remote entity” (11899) is issuing the Event Report using the information from Data Base where the Event is memorized by the method (12200), by preparing the document containing the Event Information described by (12200) as well as additional information like:
a) A graphical “print out of the map” where the event has happened (satellite and or map based)
b) An optional public security report being involved in event processing, when and if available
c) An optional health report being involved in event processing, when and if available
d) An optional multimedia file in communication with vehicle being made after event by optional activities method of operation (12120)
e) An optional comment from the “remote entity” call center person
f) Another custom defined content

Whereby the report may be issued automatically or later upon a request from a “Remote entity” (11899) control system. This report is memorized in the vehicle data base and can be sent to an external data base or to a pre defined, or allocated by a control system of the “Remote entity” (11899), specific third party, via internet.

Method of operation: “Location based Visualization System” (12400) utilizes an operation step whereby Web Server access “Remote entity” (11899) is offering to the operator, or user of the proposed system to:

### Activity 1

Look at graphical data (map or satellite photo data) an observe a position of the vehicle by addressing one or more times the vehicle object on the screen, typically presented by a specified icon in a specified color (by plurality of realization, click, gesture, laser, panel touch, remote controller, key board):
a) vehicle identification, including dedicated fleet group or cluster identification
b) if a monitored event has happened during pre defined time, whereby a typical realization could be a change of the color of the vehicle icon, or titling & blinking or other visual effects, or display text warnings
c) actual speed, acceleration of the vehicle (last update)
d) optional average speed during specific pre-defined time frame
e) reports during pre defined events
f) report of issued alerts to safety, security organizations
g) report of issues warnings to the driver
h) report of issued warning from T-Box (1000) to the driver
i) driver profile (statistical data information relate to the driver, related to the fleet, related to the cluster)
j) driver ranking, according to pre defined rules, for example, average driving behavior, hazardous driving behavior, very hazardous driving behavior, danger driving behavior or similar according to the pre defined rules.
k) Other pre defined vehicle parameters being calculated according to the T-Box, environment, traffic situation, geographic related information, limitations

### Activity 2

to enter specific new information over optical (data base) vehicle access mode:
a) An additional text format, like a report of audio communication with the driver
b) A warning and an alert which an operator (or a user) would personally like to issue to other users of the systems
c) An additional video or audio file prepared by operator & user

Method of operation: “Vehicle Data Base Processing” (12500) utilizes an operation step where the Vehicle Data Base being owned by a “Remote entity” (11899) (being realized by the plurality of the technology realizations) is statistically calculating a driving profile of a vehicle:
considering the statistical information already calculated by the T-Box,
adding new statistical evaluation of the vehicle not being calculated by T-Box
ranking the vehicle & driver profile according to the pre defined rules

Method of operation: “Fleet Data Base Processing” (12600) utilizes an operation step where the Vehicle Data Base being owned by a “Remote entity” (11899) (being realized by the plurality of the technology realizations) is statistically calculating a driving profile of all the vehicles in a fleet, whereby the individual vehicle related data base is existing, and where
all vehicles individual data bases are analyzed in the specific sub-groups based on a criteria (like, for example, vehicles with specific size, speed, with an older driver, with younger drivers, in a dedicated geographical area)
Where the thresholds for driver ranking are calculated. For example, an average driver in a specific area in 90% of the cases is driving, statistically, in summer with the speed of X km/h, not using acceleration values less than Y m/ŝ2, with detected number of events not larger than 3 (for example, the speed in defined streets with certain speed limits was exceeded). The same art of the thresholds may be advantageously set for drivers tending to drive more hazardously or for dangerous drivers.
ranking the vehicle & driver profile according to pre defined rules and calculating the derived thresholds
Preparing the reports for fleet, addressing specific sub groups

Method of operation: “Charging Functionality” (12700) utilizes an operation step where a “Remote entity” (11899) is calculating charges or fees related to specific vehicle, considering:

### Activity 1

Statistical behavior of a vehicle comprising following cases:
a) Average driving duration during specific time frames, under specific traffic, environmental and geographical conditions
b) Average driving speed during specific time frames, under specific traffic, environmental and geographical conditions
c) Average appearance of one or more specified and pre-defined events (defined and calculated by T-Box Method of operation for Event calculation (11400)) during specific time frames, under specific traffic, environmental and geographical conditions.

### Activity 2

Appearance of specific events comprising following cases:
a) Charge per number of occurrences of specific pre defined Events being calculated by (11400) or being defined as composition of different Events defined by (11400).
b) Charge per cost of activation of alerts to third party networks or issued warnings or violations of pre-defined contractual rules and conditions
c) Charges for fines being imposed by third parties to a vehicle in a fleet, as a consequence of behaviour like driving too fast within a specific area
d) Charge for other additional services and handling fees being agreed with a vehicle user

### Activity 3

Charge per issued and prepared specific Reports for Events for third party users if the “Remote entity” (11899) is a service provider

### Activity 4

Monthly Charges for the System usage, like, for example, Web Access to the Vehicle related statistics (profile information), dynamics Information (like current position and vehicle parameters) as well as Event statistics and reports.

Method of operation “Interface to an External Data Base Systems & Charging Systems” (12800) comprises bridging SW and HW functional entities, (being realized by the plurality of the realization), to address application interfaces of the external data base systems with optional external charging systems. This also advantageously comprises:
Access to Oracle Data Base Modules
Access to SAP Data Base Modules
Access to other Data Base Modules, typically or not typically used in traffic control, transportation, logistics and insurance industries
Access to charging network of the Long Range Wireless Provider (typically a cellular provider) used for T-Box (1000) access, where the charging of “Remote entity” (11899) may be imposed the user (vehicle) or owner of the specific T-Box.

Typically the charging for fees imposed to a vehicle and a driver for the cases:
“Pay HOW you drive”, “Pay after DRIVING DURATION in a specific area”, payment of the FEES for exceeding imposed driving rules, payment of the FEES for having defined events during pre defined time period, as well as payment of the individual private access to the own vehicle(s) information services may be advantageously utilized through the charging infrastructure of the long range wireless telecommunication provider (typically cellular), whose connection services are used for the operation of T-Box (1000).
   Method of operation “System Control & System Settings & T-Box Updates” (12900) comprises control function of the systems which may be realized by a specific set of access rights of the “Remote entity” (11899) over the WEB server described as:
      a) Setting and activating the dedicated T-Box hardware after installation in the car
      b) Setting of geographical areas related to definitions of specific events
      c) Setting of environmental conditions related to definitions of specific events
      d) Setting of traffic conditions related to definitions of specific events
      e) Setting of pre defined observation times for specific events
      f) Setting of pre defined observation times for calculation of event occurrences
      g) Setting content, layout, formats and other features of the Event Reports
      h) Setting content, layout, formats and other features of statistical evaluation of Events being used for profiling specific drivers.
      i) Setting content, layout, formats and other features of statistical evaluation of Events being used for profiling of specific fleets or user groups having more than one vehicle in a group, including rules for calculations of the thresholds for vehicle profile marking.
      j) Setting charging values, approaches and rules associated to specific events or appearances of events statistics. This includes commercial charging, as well as punishment fees, resulting from violations of pre defined rules.
      k) Setting charging values, approaches and rules associated to specific events or appearances of events statistics.
      l) Setting firmware updates time, approach and content.
      m) Setting, enabling, disenabling, interfaces to external data bases (including bridges to Oracle and SAP) as well as charging systems.
      n) Setting access rights to call center employees
      o) Setting access rights to “Remote entity” (11899) information network usage
      p) Setting access rights to Administrative personnel
      q) Other settings being customized upon requests of a “Remote entity” (11899)” Proposed System being described by proposed hardware and Method of operation may be advantageously used for definition and deployment of the different business processes.

### Industrial Applicability/Business Processes:

The new innovative Business processes are proposed, which are only possible due to the utilization of the proposed apparatus (1000) and (2000) and to the related proposed Method of Operation (11000) and (12000). Proposed business processes are not known as “state of the art”. Each described and newly proposed business process contains a short description of the target market, target services and target charging strategy.

### Following Business Processes (20000) are Proposed:

Business Process related to a Service Company Business Model (20100):
It is based on newly proposed and significantly innovative services in addition to the state of state services, which represent a significant value to a customer. Typical customers of service companies are:
   a) transportation fleets like:
   1. vehicle leasing companies
   2. public fleets like school busses,
   3. Taxi organizations
   4. logistics companies, like post delivery companies
   5. organizations like chemistry-, oil-, steel-, mining-industry (with more than 10 vehicles in fleet)
   b) organizations having own fleets, like emergency organization (fire protection, health), defense organizations, security organizations (example police)
   c) smaller enterprises (with smaller fleets under 100 vehicles)
   d) private organizations, like “worried parents organizations” and “community kids tracking”, being interested to track cars of their kids and to asses the specific pre-defined events over a specific group of vehicles
   e) private persons, with a need to have a service for one or more vehicles
   f) automotive national Clubs, for extending their services to drivers, by typically reselling the services from a Service company
   g) Certification, Vehicle control as well as Automotive repair chain organization, for extending their services to drivers by typically reselling the services from a Service Company

Customer gets following proposed services:
Tracking information of the vehicle, being accessible over a WEB service (sate of the art), but due to newly proposed system (apparatus+method of operation) customer is obtaining AT LEAST one additional services.
a) SERVICE ITEM 1 (20110) Vehicle Trajectory Report in s case of a pre defined event from (12200)
b) SERVICE ITEM 2 (20120) Vehicle driving profiles based on statistics related to specific pre-defined events, being conceptually defined and calculated by the (11400), and processed by (11200), (12300), (12500) and (12600)
c) SERVICE ITEM 3 (20130) Vehicle warnings in case of the pre defined events, being calculated by (11300)
d) SERVICE ITEM 4 (20140) Commitment of automatically placing alerts to a vehicle according to (11600)
e) SERVICE ITEM 5 (20150) Commitment of automatically placing alerts to security and safety organizations according to (12100)

Customer pays according to the following options:
a) upfront payment (covering partial coverage 1 of cost for installation of the T-Box (1000) in a vehicle and for partial cost coverage 2 for T-Box (1000) cost, where the partial coverage 1 and partial coverage 2 may vary from 0% to 100%)
b) payment for the services in more than one installments, typically a monthly payment

Business Process prepared for provisioning the Service to Insurance Companies (20200):

It is based on newly proposed and significantly innovative services in addition to the state of of the art services, which bring significant value to a customer.

Customer gets following proposed services:
a) SERVICE ITEM 1 (20210) Vehicle driving profiles based on statistics related to specific pre-defined events, being conceptually defined and calculated by the (11400), and processed by (11200), (12300), (12500) and (12600). This feature allows for insurance companies to profile the drivers and group driver behaviors in different risk related categories, which then essentially provides means of insurance optimization as well as risk optimisation, while offering very attractive insurance offers to low risk drivers.
b) SERVICE ITEM 2 (20220) Vehicle Trajectory Reports in case of pre defined events from (12200), where trajectory recovery and crash reports in the case of an incident/crash is an essential and very valuable service provision. This feature allows for optimization of the internal processes of insurers, shorter time in the insurance damage process, for stronger support in legal disputes, all of which inherently reduces a total cost of operations.
c) SERVICE ITEM 3 (20230) Tracking information of a vehicle, being accessible from

WEB service (sate of the art), but due to newly proposed system (apparatus ₊method of operations) customer is obtaining AT LEAST one additional services like:
1. Commitment of automatically placed alerts to a vehicle according to (11600)
2. Commitment of automatically placed alerts to the security and safety organizations according to (12100)

Offers 1) and 2) of feature c) are special services being acquired by insurance companies, because they may reduce the insurance damages of insured people in vehicles, minimize insured damages to third parties and publicly result in more safety whilst driving, which is a motivation of many companies.

Customer pays according to the following options:
a) upfront payment (covering partially 1 of cost for installation of the T-Box (1000) in the vehicle and for partial cost coverage 2 for T-Box (1000) cost, where the partial coverage 1 and partial coverage 2 may vary from 0% to 100%)
b) payment for the services in more than one installments, typically per month where the payments are typically agreed for clusters having essentially more vehicles, typically more than 1000 pieces. The system is connected to Insurance Data Base systems by proposed interfaces, typically to SAP and/or Oracle Data Bases.

Business Process prepared for Service provisions for “Traffic Organizations” being defined as organizations responsible for both traffic regulations and traffic optimizations, as well as for charging for the used infrastructure within specific geographical areas (20300):

It is based on newly proposed and significantly innovative services in addition to the state of the art services, which are essentially valuable to a customer.

Customer gets the following proposed services:
a) SERVICE ITEM 1 (20310) Cluster (more than one vehicles in the monitoring system) driving profiles based on statistics related to pre-defined events, being conceptually defined and calculated by (11400) and processed by (11200), (12300), (12500) and (12600). This feature allows for profiling of behavior of drivers within specific geographical areas according to their habits, and for planning of the charging strategy.
b) SERVICE ITEM 2 (20320) Vehicle (individual) driving profiles based on statistics related to pre-defined events, being conceptually defined and calculated by (11400) and processed by (11200), (12300), (12500) and (12600). This feature allows for profiling of behavior of a particular driver. This may be a basis for regular fee calculations using the traffic infrastructure within specific geographical areas. The fees to the end user (being imposed by an organization) are in such a case typically on per month bases and are not event based or triggered. For example, all of the users are grouped in categories by the amount of usage of traffic infrastructure, into smaller users, medium users, large user with a small number of grading, making the charging of an end user fairly simple, like paying, for example, a premium fee or a standard and lite fee.
c) SERVICE ITEM 3 (20330) Pre defined event reports, from (12200), where pre-defined events reports are used for “Pay HOW you drive” (related to payment per pre defined Event) business model. This means the service providers in charge (traffic regulatory companies) are issuing the charges related to the events, like typically average speed of passing over a defined area, with average below one limit 1, one charge, passing between limits 2 and 3, a second charge (higher speed−higher charge) and passing between limits 3 and 4, a third charge (much higher charge), passing with speed limit above limit 4 (a punishment fee). The second application example of this business process would be speed related fee in a case of snow (environment) or in a city center (geographic area) in rush hour usage (time period) and is calculated differently related to time, geography and environment in combination with average speed.
d) SERVICE ITEM 4 (20340) Tracking information of a vehicle, being accessible from WEB service (state of the art), but due to newly proposed system (apparatus+method of operations) traffic participants are advantageously obtaining additional features like:
1) automatically sending alerts to the vehicles according to (11600) if traffic participants are violating pre-defined rules in areas and/or if specific events are important for participant security
2) Automatically sending alerts to security and safety organizations according to (12100) within specific geographical areas.

Traffic participant pays according to the following options:
e) Specific regular (time) fees depending on the customer profile
f) Specific payments (fees and punishment fees) for the occurrence of pre-defined events on “pay how you drive” basis
where a “traffic company” is paying a monthly fees for using the technology and the services from a general service provider, or is paying the in one time manner, thus providing the services of the systems and its operation on its own and by its own staff.
   Typical proposed Business Case Study
Typical “traffic organization” business case model may look advantageously like described in continuation. A local town government is imposing an obligation for all the cars being registered in a town to have “T Box” (1000) installed. The installation and T-Box as a hardware is free for traffic participants and it is covered by the local government. The local government is appointing the service company to provide traffic regulation in the town center. This service company is deploying the complete Method of Operation (11000 and 12000), and defusing a charging strategy, a fee strategy and related important events. The local service company is licensing the System solution. The local government is paying the operation fee to the Service Company. The service company is imposing the rules also considering the “pay HOW you drive” strategy, on the circular fast multi lane roads around the town area, as well as on a number of accesses to the town gates, where the access through specific gate is twice more expensive as other gate, and where the duration of the stay in town centre West Part is weighted twice more as being in the East Part of the town, with a better traffic infrastructure. In the circular multi lane road category under 30 miles/h is not charged, between 30 and 35 miles/h is charged by a value of X $, between 35 miles and 50 miles/h by Y$, where Y is 2 times X. If someone is driving more than 50 miles/h, the fee of 10 times X is imposed to the driver. The charging to the drivers is imposed by a cellular network provider monthly bill or by an Internet network provider. The second charging option is, for example, for each participant to pay Z$ per month to the local government by registration of the car, and by renewal of the registration next year. A bonus pay back is paid to traffic participants being careful in traffic, obeying the rules, and additional fee is imposed to those driving fast, including fines. Having T-Box on the board as a regulation, warning systems to the drivers are applied to reduce the risk of accidents, and in the same time alerts to the emergency organizations and public safety may be timely dispatched especially in case of crashes. This may save lives and contribute to the overall public security.

The local government and people in the town
1. have a better regulated traffic with lower impact of traffic jams and smaller pollution in specified parts of the town
2. have less traffic accidents in the town, because of the regulated speed and educated traffic participants, where the fees for violation of the rules are automatically monitored and issued
3. have safer traffic with less consequences of the traffic incidents due to alert functions to emergency and safety
4. have safer life, due to possibility of the traffic control of the specific violation of the imposed rules, which in specific cases may be followed by the local police
5. have no cost for the benefits, because the return on the investment are within the year paid by those traffic participants who are willing to pay for the access service by the car in faster manner (socially correct), and by those who are violating the rules.

Proposed business processes are bringing clear advantages, when compared to state of the art business processes, being related to the usage of the telematics solutions. Proposed business processes are feasible due to the usage of the proposed System: based on proposed apparatus and proposed Method of operation.

What is claimed is:

1. A telematics system comprising T-Box (1000) apparatus and Back End Functionality (2000) and Method of Operation (10000)
where T-Box (1000) contains
An inertial unit (200), containing MEMS or NEMS based 3D inertial sensors (210) including 3D gyroscope functionality (210)
A long range wireless communication unit (120)
A global navigation satellite (GNSS) system unit (110)
A processing and a control unit (130)
A memory (310)
where Back End (2000) is a virtual processing entity, being realized on remote servers and being connected internally and externally by an IP network and containing:
A virtual processing entity (2500), which itself comprises:
a) A Graphic Machine with Human Machine Interface with Map Content (2400)
b) A Virtual Vehicle Data Base (2200)
c) A Virtual Group of the Vehicle Data Base (2300)
A WEB Interface related to the System Operations (2110)
A WEB Interface related to the Supervision & Control Unit (2120)
A Gateway to long range wireless network systems, over which the entity (120) of T-Box (1000) may be accessed
where applied Method of operation (10000) comprises activities related to T-Box (11000) and to activities related to Back End (12000), whereby following activities are executed in scope of (11000):
A Calculation of Real Time Position Data (11100), where the inertial unit (200) data is used and processed
A Calculation of Real Time Vector Trajectory of the Vehicle (11200)
A Calculation of Event Detection (11400), where Event is defined as a plurality of specific dynamic sets of parameters achieved by a vehicle during a specified time period of observation, and where dynamic sets of parameters are related to vector values of speed, acceleration, external and internal forces, as well as to their changes, and statistical appearances over specified time
A Calculation of Behavior of the Driver & Vehicle (11300) by statically processing data related to vehicle dynamics and specified detected Events (11400), or combinations of events
A Calculation of Vector Trajectory of a Vehicle after specific Event has happened (11500), where the vehicle dynamics data, processed by a processor (130) and stored in the memory (310), is used for a reconstruction of the vehicle trajectory before Event occurrence.
whereby the executed activities in the scope of (12000) are
“Back End Event Actions” (12200), registering in a date base the event related information: event art, time stamp, geographical position, vector acceleration information, vector velocity information and system action on registered event art
“Event Report Preparation and Handling” (12300), issuing a computer program readable document containing a graphical print out of locations where events happened, combined with event art, time stamp, geographical position, vector acceleration information, vector velocity information and system action on registered event art
“Location based Visualization System” (12400) where via WEB server interface a position of a vehicle, its identification, acceleration vector and velocity vector are observed over the geographical map, as well as related icons to permiting an access to associated event reports and statistical behavior information
“Vehicle Data Base Processing” (12500), statistically calculating a vehicle behavior, by entering new data and comparing its behavior with a referent vehicle category group behavior based on statistical data of more vehicles
“Fleet Data Base Processing” (12600), statistically calculating a vehicle category group behavior by entering data from vehicle being categorized as a member of a group
“System Control & System Settings & T-Box Updates (12900), executed via WEB server interface software which allows for updates of the T-Box (1000) and control orders to T-Box (1000) functional blocks
where proposed apparatus (1000) and back end (2000) are realized by plurality of the technologies
where proposed Method of Operation (100000) is executed by plurality of the execution approaches for each proposed activity within proposed Method of Operation activities (11000) and (12000).

2. Telematics system comprising T-Box (1000) apparatus and Back End Functionality (2000) and Method of Operation (10000) described in claim 1 with
an inclusion of a short range wireless connectivity (320) in the T-Box (1000), by the plurality of the short range wireless technologies, and by the plurality of the realization.

3. Telematics system comprising T-Box (1000) apparatus and Back End Functionality (2000) and Method of Operation (10000) described in claim 1 with
inclusion of an entity providing connection or provision of additional (non inertial) sensors, (330) in the T-Box (1000), by the plurality of the sensor functions, and by the plurality of its realization.

4. Telematics system comprising: T-Box (1000) apparatus and Back End Functionality (2000), and Method of Operation (10000) described in claim 1 with
inclusion of an entity, providing a microphone functionality (340) in the T-Box (1000), by the plurality of the realization.

5. Telematics system comprising T-Box (1000) apparatus and Back End Functionality (2000) and Method of Operation (10000) described in claim 1 with
inclusion of an entity, providing speaker functionality (350) in the T-Box (1000), by the plurality of the realization.

6. Telematics system comprising T-Box (1000) apparatus and Back End Functionality (2000) and Method of Operation (10000) described in claim 1 with
an inclusion of an entity, providing a wired connection to the vehicle & the driver, (340) in the T-Box (1000), by the plurality of the physical interfaces, communication protocols, and by the plurality of realizations.

7. Telematics system comprising T-Box (1000) apparatus and Back End Functionality (2000) and Method of Operation (10000) described in previous Claims with Method of operation activities (11400) related to Event detection, where also Environment related influences are additionally used for the Event detection, by the plurality of the Environmental influences, where the environmental influences are at least one of the following:
Rain Detection
Rain Intensity
Snow Detection
Snow Intensity
Wind Detection
Wind Intensity
Temperature Level
Humidity Level
Air quality sensor levels (related to CO2)
Air quality sensor levels (related to dust particle density)
Air quality sensor levels (related to gases, without CO2)

8. Telematics system comprising T-Box (1000) apparatus and Back End Functionality (2000) and Method of Operation (10000) described in claims 1 to 6 with Method of operation activities (11400) related to Event detection, where also Driver Related influences are used additionally for the Event detection, by the plurality of the Driver influences, where the driver related influences are at least one of the following influences:
Driving in a specific geographical area
Driving in a specific geographical area during specific period of a day
Driver average behavior from the past
Driver age
Driver audio commands placed towards the vehicle
Driver gestures
Driver face
Driver actions related to pressing mechanical buttons
Change of driver positions within the car during driving

9. Telematics system comprising T-Box (1000) apparatus and Back End Functionality (2000) and Method of Operation (10000) described in claim 1 with Method of operation activities (11300) related to Behavior of the Driver & the Vehicle, where Environment related influences during specific time of observation with a specified duration are used additionally for the Behavior of the Driver & the Vehicle (11300) calculations, by the plurality of the Environmental influences, where the environmental influences are at least one of the following:
Rain Detection
Rain Intensity
Snow Detection
Snow Intensity
Wind Detection
Wind Intensity
Temperature Level
Humidity Level
Air quality sensor levels (related to CO2)
Air quality sensor levels (related to dust particle density)
Air quality sensor levels (related to gases, without CO2)

10. Telematics system comprising T-Box (1000) apparatus and Back End Functionality (2000) and Method of Operation (10000) described in claim 1 with Method of operation activities (11300) related to Behavior of the Driver & Vehicle, where also Environment related influences during specific time of observation with a specified duration are used additionally for the Behavior of the Driver & Vehicle (11300) calculations, by the plurality of the Environmental influences, where the environmental influences are at least one of the following:
Driving in a specific geographical area
Driving in a specific geographical area during specified period of a day
Driver average behavior from the past
Driver age
Driver audio commands placed towards the vehicle
Driver gestures
Driver face
Driver actions of pressing mechanical buttons
Change of driver positions with the car during driving

11. Telematics system comprising T-Box (1000) apparatus and Back End Functionality (2000) and Method of Operation (10000) described in previous claims where Method of operation activities (11400) containing “stability events” (11410) detection are further specified as “Roll-over” Event detection (11411) being calculated in a way that:
a predefined time window “Time Window 1” is set
a predefined time window “Time Window 2” is set to be greater than “Time Window 1”
a predefined time window “Time Window 3” is set
a predefined time window “Time Window 4” is set to be smaller than “Time Window 3”
a predefined acceleration threshold “Acceleration threshold 1” is set
a predefined acceleration threshold “Acceleration threshold 2” is set to be smaller in magnitude than “Acceleration threshold 1”
a predefined acceleration threshold 3 “Acceleration threshold 3” is set to be smaller in magnitude than “Acceleration threshold 2” but smaller than 0 m/ŝ2
an average acceleration at Z-Axis (perpendicular to the driving surface) “az average 1” is observed within “Time Window 1”
an average acceleration at Z-Axis (perpendicular to the driving surface) “az average 2” is observed within “Time Window 2”
A variance of acceleration vector “acceleration variance” is observed within “Time Window 4”
if the “az average 1” is larger than “Acceleration threshold 1” an event is detected
if the “az average 1” is not larger than “Acceleration threshold 1” it is checked if the “az average 2” is larger than “Acceleration threshold 2” and if so an event is detected
if and when an event is detected start a watchdog timer “time counter”
if an event is detected check if the “acceleration variance” is smaller than “Acceleration threshold 3” or “time counter” exceeds “Time Window 3”, and if so, send full roll-over report including estimate of angles in final position by measuring gravity components on all accelerometer axes

12. Telematics system comprising T-Box (1000) apparatus and Back End Functionality (2000) and Method of Operation (10000) described in previous claim, where Method of operation activities (11400) containing “stability events” (11410) detection is further specified as Roll-over” Event detection (11411) where
“Time Window 1” is larger than 0.2 s
“Time Window 2” is larger than 1 s
“Time Window 3” is larger than 2 s
“Time Window 4” is larger than 0.5 s
“Acceleration threshold 1” is larger in magnitude than 0.4 g, where g is 9.81 m/s2
“Acceleration threshold 2” is smaller in magnitude than 0.1 g, where g is 9.81 m/s2
“Acceleration threshold 3” is smaller in magnitude than 0.08 g, where g is 9.81 m/s2

13. Telematics system comprising T-Box (1000) apparatus and Back End Functionality (2000) and Method of Operation (10000) described in claims 1 to 8 where Method of operation activities (11400) containing “stability events” (11410) detection is further specified as Pitch” Event detection (11412)
Being calculated in a way that
A threshold “threshold pitch” is set [in degrees]
A value for integration time “Integration time” is set
A value of “angular velocity” is integrated over the “integration time” resulting in a value called “change of pitch angle”
If the absolute value of “change of pitch angle” is larger than “threshold pitch” the event is detected.

14. Telematics system comprising T-Box (1000) apparatus and Back End Functionality (2000) and Method of Operation (10000) described with claim 13 where Method of operation activities (11400) containing “stability events” (11410) detection is further specified as Pitch” Event detection (11412)
Where “threshold pitch” is larger than 5 degrees
Integration time is larger than 0.4 sec

15. Telematics system comprising T-Box (1000) apparatus and Back End Functionality (2000) and Method of Operation (10000) described in claims 1 to 8 where Method of operation activities (11400) containing “stability events” (11410) detection is further specified as “Under Steering & Over Steering” Event detection (11415)
Being calculated in a way that
a value for observation time window “observation window 1” is set
a value for acceleration threshold “acceleration threshold 1” is set
a value for threshold “understeering threshold” is set
a value for velocity threshold “velocity threshold” is set
“Lateral acceleration” is defined as an acceleration component perpendicular to the direction of driving during a specified time increment
“Averaged lateral acceleration” is calculated as “lateral acceleration” averaged over the “observation window 1” time
“Averaged yaw rate” is calculated as “angular rate” measured on axis orthogonal to vehicle plane and averaged over the “observation window 1” time
“directional velocity estimate” is defined as a velocity component in the direction of the movement
“lateral acceleration estimate” is calculated as “averaged yaw rate” multiplied with “directional velocity estimate”
It is checked if the absolute value of “averaged lateral acceleration” is larger than “acceleration threshold 1” and if so, then “average lateral acceleration” component is deducted from “lateral acceleration estimate”, then it is checked if this number is larger than “understeering threshold”, and if so, it is checked if vehicle velocity at that moment is larger than “velocity threshold”, if so an event is detected.

16. Telematics system comprising T-Box (1000) apparatus and Back End Functionality (2000) and Method of Operation (10000) described in claim 15 where Method of operation activities (11400) containing “stability events” (11410) detection is further specified as “Under Steering & Over Steering” Event detection (11415)
Being calculated in a way that
“observation window 1” is smaller than 1 s.
“acceleration threshold 1” is larger than 0.4 g, where g=9.81 m/s2
“understeering threshold” is larger than 0.4 g, where g=9.81 m/s2
“velocity threshold” is larger than 8 m/s

17. Telematics system comprising T-Box (1000) apparatus and Back End Functionality (2000) and Method of Operation (10000) described in claims 1 to 8 where Method of operation activities (11400) containing “road type and vibration monitoring” events (11420) detection is further specified as “On Road & Off Road Usage” Event detection (11421)
Being calculated in a way that
a value for time window “observation window1” is set
a value for time window “observation window2” is set
a value for “slope” is set according to vehicle speed
a value for “starting vibrations” is set
“Road type threshold” is calculated by multiplying “starting vibrations” with “slope”
“Acceleration variance” is calculated as a variance of acceleration vector over “observation window1”
the calculated “Acceleration variance” is compared to “Road type threshold” and if it exceeds the value of a threshold over “observation window2” then an event of off-road usage is detected.

18. Telematics system comprising T-Box (1000) apparatus and Back End Functionality (2000) and Method of Operation (10000) described in previous claim where Method of operation activities (11400) containing “road type and vibration monitoring” events (11420) detection is further specified as “On Road & Off Road Usage” Event detection (11421)
Being calculated in a way that
“observation window 1” is greater than 1 s.
“observation window 2” is greater than 10 s.
“Slope” is below 1 if vehicle speed is below 40 km/h
“Slope” is between 1 and 2 if vehicle speed is between 40 km/h and 100 km/h
“Slope” is above 2 if vehicle speed is above 100 km/h
“starting vibrations” is greater than 0.3 m/s2 and below 3 m/s2.

19. Telematics system comprising: T-Box (1000) apparatus and Back End Functionality (2000) and Method of Operation (10000) described in claims 1 to 8 where Method of operation activities (11400) containing “road type and vibration monitoring” events (11420) detection is further specified as “Moderate risk of back disorders” Event detection (11422) and “High risk of back disorders” Event detection (11423)
Being calculated in a way that
a value of “Exposure Action Value” is set
a value of “Exposure Limit Value” is set
Peak values of acceleration between two zero crossings are identified for each of the accelerometer axes and are stored as “acceleration peaks”
Each of the “acceleration peaks” is raised by power of six and stored as “acceleration peaks to the power six”
“acceleration dose” is calculated as the sixth root of the sum of all the acceleration peaks being powered to six, from “acceleration peaks to the power six” found on interval of interest
a duration of daily exposure to vibrations is monitored and stored as “duration of daily exposure”
For each day, duration of daily exposure is divided by the time duration over which the “acceleration dose” of each of the accelerometer axis is monitored and these daily values are summed up. The sixth root of this sum represents “average daily dose” and it is calculated for each axis.
“Scale factor” is defined for each of the axis
“Acceleration dose” for each axis of accelerometer is multiplied by a corresponding “scale factor” and raised to the sixth power and results for all three axis is sumed up and after their addition, the sixth root of the sum is calculated, defining the “equivalent static compressive stress”
“Average daily dose” for each axis of accelerometer is multiplied by a corresponding “scale factor” and raised to the sixth and results for all three axis is summed up and after addition the sixth root of the summary defines “daily equivalent static compressive dose”
If “daily equivalent static compressive dose” exceeds “Exposure Action Value” an event of “Moderate risk of back disorders” (11422) is detected
If “daily equivalent static compressive dose” exceeds “Exposure Limit Value” an event of “High risk of back disorders” (11423) is detected.

20. Telematics system comprising T-Box (1000) apparatus and Back End Functionality (2000) and Method of Operation (10000) described in previous claim, where Method of operation activities (11400) containing “road type and vibration monitoring” events (11420) detection is further specified as “Acceleration Dose” Event detection (11422) where:
The value of “Exposure Action Value” is set to 0.5 MPa
The value of “Exposure Limit Value” is set to 0.8 MPa
The value of “scale factor” is larger than 0.1

21. Telematics system comprising T-Box (1000) apparatus and Back End Functionality (2000) and Method of Operation (10000) described in claims 1 to 8 where Method of operation activities (11400) containing “Crash” events (11430) detection is further specified as “Non Severe Crash” Event detection (11424)
Being calculated in a way that
a value for observation time window “Observation Window 1” is set
a value of “short-term delta velocity” is calculated by integrating the value of acceleration vector over “Observation Window 1”
a value of “crash end threshold” is set
Simultaneously the “Principal Direction of the Force; PDOF” is calculated, being defined as an angle of force in horizontal and vertical plane, relative to the vehicle frame, by the calculation of the argument of “Short-term delta velocity”
“Normalization factor” is set of pre-defined scalar values determined depending on PDOF (in both horizontal and vertical planes) for each of accelerometer components
“Normalized short-term delta velocity” is calculated by multiplying “Short-term delta velocity” by a pre defined “Normalization factor” matched to calculated PDOF at a moment
If the absolute value of “Normalized short-term delta velocity” is larger than 1, the an event of “generalized crash” is detected, and PDOF calculated at that very moment is “Crash PDOF”, while “Normalization factor” valid at that moment is “Crash normalization factor”
The timer started to measure the duration of the “Generalized crash” event
“Normalized accelerometer vector” is calculated by multiplying acceleration vector components by “Crash normalization factor” values, related to specific vector component
Value of “normalized short-term delta velocity” is further calculated by integrating the value of “normalized acceleration vector” over “Observation Window 1” and if the absolute value becomes smaller than “Crash end threshold”, the end of “generalized crash event” is detected
“Crash delta velocity” vector is calculated by integrating “Normalized accelerometer vector” over duration of crash event
“Severe threshold” value is set, which is required not be surpassed to declare the crash as non-severe
“Crash delta velocity” is compared to “Severe threshold” and if it is not surpassed “Non-severe crash” is detected.

22. Telematics system comprising T-Box (1000) apparatus and Back End Functionality (2000) and Method of Operation (10000) described in claims 1 to 8 Method of operation activities (11400) containing “Crash” events (11430) detection is further specified as
“Severe Crash” Event detection (11431)
Being calculated in a way that
a value for observation time window “Observation Window 1” is set
a value of “short-term delta velocity” is calculated by integrating value of acceleration vector over “Observation Window 1”
a value of “Crash end threshold” is set
“Severe threshold” value is set, which is required to be surpassed to declare the crash as severe
Simultaneously, the “Principal Direction of the Force; PDOF” is calculated, being defined as an angle of force in horizontal and vertical planes, relative to the vehicle frame, by the calculation of the argument of “short-term delta velocity”
“Normalization factor” is set of pre-defined scalar values determined depending on PDOF (in both horizontal and vertical plane) for each of the accelerometer components
“Normalized short-term delta velocity” is calculated by multiplying “Short-term delta velocity” by pre defined “Normalization factor” matched to the calculated PDOF at a moment
If the absolute value of “Normalized short-term delta velocity” is larger than 1, the event of “generalized crash” is detected and PDOF calculated in that very moment is “crash PDOF”, while “Normalization factor” valid at that moment is “Crash Normalization factor”
The timer is started to measure the duration of the “Generalized crash” event
“Normalized accelerometer vector” is calculated by multiplying the acceleration vector components by “Crash Normalization factor” components
Value of “normalized short-term delta velocity” is further calculated by integrating the value of “Normalized acceleration vector” over “Observation Window 1” and the if the absolute value becomes smaller than “Crash end threshold”, the end of generalized crash event is detected
“Crash delta velocity” vector is calculated by integrating “Normalized accelerometer vector” over duration of a crash event
“Crash delta velocity” is compared to “Severe threshold” and if it is surpassed a “severe crash” is detected.

23. Telematics system comprising T-Box (1000) apparatus and Back End Functionality (2000) and Method of Operation (10000) described in claims 21 and 22 where Method of operation activities (11400) containing “Crash” events (11430) detection is further specified as “Severe Crash” Event detection (11431) where
“Severe threshold” is measured by abbreviated injury Scale (MAIS), having grades from 0 to 7, where the threshold of determining severe and non severe crashes is set to the value of 3, where all crashes in the scale with mark 3 and larger are claimed as severe crashes, and all crashed below mark 3 as non-severe crashes.
A value for the threshold “Severe crash probability 75+” is set
If “Crash delta velocity” surpasses the “Severe crash probability 75+” then the probability that a severe crash is more severe than MATS 3 crash grade is higher than 75%
If “Crash delta velocity” does not achieve “Severe crash probability 75+” then the probability that a severe crash is more severe than MAIS 3 crash grade is linearly in between 25% and 75%, whereas 25% is a lowest detectable “Severe crash” event (“Crash delta velocity”=“Crash threshold”)

24. Telematics system comprising T-Box (1000) apparatus and Back End Functionality (2000) and Method of Operation (10000) described in claims 21 to 23 where Method of operation activities (11400) containing “Crash” events (11400) detection is further specified in a way that
In a case of a detection of multiple crash events during short time period or a detection of roll-over event, a final “Crash delta velocity” as calculated in claims 21-23 should be scaled with “statistic factor” that not lower than 1.2

25. Telematics system comprising T-Box (1000) apparatus and Back End Functionality (2000) and Method of Operation (10000) described in claims 1 to 8 where Method of operation activities (11400) containing “Driver related events” (11440) detection is further specified as “Driving under influence” Event detection (11441)
Being calculated in a way that:
a profile of a vehicle & a driver typical behavior is available (11300), and has been calculated statistically in the past, including events profile relevant to driver behavior during specific hours, which is reflected in number Ro (behavior risk), where Ro can take values greater than and equal to zero, where zero means no specific risks
a specific age risk factor is set and numerically expressed as R1, where R1 can take values greater than and equal to zero, where zero means no specific risks
a specific past related risk factor, relevant to driving under the influence in the past is set and numerically expressed as R2, where R2 can take values greater than or equal to zero, where zero means no specific risks
a specific past related risk factor relevant to the public fee register is set and numerically expressed as R3, where R3 make take values greater than or equal to zero, where zero means no specific risks
a specific insurance related risk factor relavant to the insurance company internal rules is set and numerically expressed as R4, where R4 can take values greater than or equal to zero, where zero means no specific risks
a specific observation time “time window 1” is set
a specific acceleration threshold for detection of sub-event “harsh braking” is set
a specific acceleration threshold for detection of sub-event “fast acceleration” is set
a specific “fast cornering” threshold for detection of sub-event “abrupt changing of the driving direction” is set
a specific number “importance factor fatigue” is set, to be multiplied with an occurrence of the detected event “fatigue” during specifically defined observation time “time window 1”, to express the importance of the specific sub-event, where numbers greater than zero are used and where number zero means no importance
a specific number “importance factor slide slip” is set, to be multiplied with an occurrence of the detected event “slide slip” during specifically defined observation time “time window 1”, to express the importance of the specific sub-event, where numbers greater than zero are used, and where number zero means no importance
a specific number “importance factor spinning” is set, to be multiplied with an occurrence of the detected event “spinning” during specifically defined observation time “time window 1”, to express the importance of the specific sub-event, where numbers greater than zero are used, and where number zero means no importance
a specific number “importance harsh braking” is set, to be multiplied with an occurrence of the detected event “harsh braking” during specifically defined observation time “time window 1”, to express the importance of the specific sub-event, where numbers greater than zero are used, and where number zero means no importance
a specific number “importance fast acceleration” is set, to be multiplied with an occurrence of the detected event “fast acceleration” during specifically defined observation time “time window 1”, to express the importance of the specific sub-event, where numbers greater than zero are used, and where number zero means no importance
a specific number “importance fast turning” is set, to be multiplied with an occurrence of the detected event “fast turning” during specifically defined observation time “time window 1”, to express the importance of the specific sub-event, where numbers greater than zero are used, and where number zero means no importance
a specific number “importance of geographical area” is set, to be used for scoring of “being in the specific geographical area” during specifically defined observation time “time window 1”, where numbers greater than zero are used, and where number zero means no importance of the geographical area
a specific number “importance of environment” is set, to be used for scoring of “being under the influence of specific weather conditions” during specifically defined observation time “time window 1”, where numbers greater than zero are used, and where number zero means no importance of the specific weather conditions
a specific number “importance of traffic” is set, to be used for scoring of “being under the influence of specific traffic conditions” during specifically defined observation time “time window 1”, where numbers greater than zero are used, and where number zero means no importance of the specific traffic conditions
“driving under the influence score threshold” is set, which is a positive number, and when the number is smaller the detection probability of an event is greater, or the score required to detect the event driving under influence is smaller
In the predefined “time window 1”, a number of the occurrence of events: driving under fatigue, slide slip, spinning, harsh braking, fast acceleration, fast turning is calculated by detection of these events using T-Box (1000)
“Driving score” is calculated as a sum of:
Ro+R1+R2+R3+R4+
30 “importance factor fatigue” * number of occurrences of event “fatigue” during “time window 1”,+
+ “importance factor slide slip” * number of occurrences of event “side slip” during “time window 1”,+
+ “importance factor spinning” * number of occurrences of event “spinning” during “time window 1”,+
+ “importance factor fast braking” * number of occurrences of event “fast braking” during “time window 1”,+
+ “importance factor fast acceleration” * number of occurrences of event “fast acceleration” during “time window 1”,+
+ “importance factor fast turning” * number of occurrences of event “fast turning” during “time window 1”,+
+ “importance of geographical area” +
+ “importance of environment” +
+ “importance of traffic”
If “Driving score” is equal or greater than “driving under influence score threshold” the event “driving under influence” is detected.

26. Telematics system comprising T-Box (1000) apparatus and Back End Functionality (2000) and Method of Operation (10000) described in claims 1 to 8 where Method of operation activities (11400) containing “Driver related events” (11440) detection is further specified as “Driving fatigue” Event detection (11441)
Being calculated in a way that:
“moving average window” is set
“observation window 1” is set
“observation window 2” is set
“observation window 3” is set
“observation window 4” is set
“absolute value of acceleration threshold” is set
“vehicle speed threshold” is set
“angle threshold fatigue” is set
“angle threshold correction” is set
a moving average of acceleration on X-axis (longitudinal to vehicle) “ax average” is observed within the “moving average window”
if the absolute value of “ax average” is not greater than the “absolute value of acceleration threshold” and if the velocity of the vehicle is greaten than “vehicle speed threshold” and if the change of vehicle heading angle as calculated by T-Box (1000) within “observation window 2” is less than “angle threshold” than the new “observation window 3” is started where a sudden and opposite (during the observation window 4) change of vehicle heading is observed, with angle change greater than “angle threshold correction”, and if the sudden and opposite change of vehicle heading happens, the event fatigue is detected.
if the vehicle heading angle change as calculated by T-Box (1000) within “observation window 2” is less than “angle threshold” than the new “observation window 3” is started where the sudden and opposite change (within the duration of the observation window 3) of vehicle heading is observed, with an angle change greater than “angle threshold correction”, and if the sudden and opposite change of vehicle heading happens, the event fatigue is detected.
During the “observation window 1”, the constant acceleration of the vehicle is observed under “Absolute value of acceleration threshold” and
if the velocity of the vehicle is greater than “vehicle speed threshold” and if the vehicle heading angle change as calculated by T-Box (1000) during “observation window 2” is less than “angle threshold” than the new “observation window 3” is started where the sudden and opposite change (within the duration of the observation window 3) of vehicle heading is observed, with angle change greater than “angle threshold correction”, and if the sudden and opposite change of vehicle heading happens, the event fatigue is detected.

27. Telematics system comprising T-Box (1000) apparatus and Back End Functionality (2000) and Method of Operation (10000) described in claims 25 where Method of operation activities (11400) containing “Driver related events” (11440) detection is further specified as “Driving fatigue” Event detection (11441)
Being calculated in a way that
“moving average window” is less than 1 s
“observation window 1” is longer than 5 s
“observation window 2” is longer than 5 s
“observation window 3” is longer than 5 s
“observation window 4” is shorter than 0.3 sec
“Absolute value of acceleration threshold” is lower than 0.05 g, where “g” is 9.81 m/s2
“vehicle speed threshold” is greater than 10 m/s
“angle threshold fatigue” is smaller than 5 degrees
“angle threshold correction” is greater than 10 degrees

28. Telematics system comprising T-Box (1000) apparatus and Back End Functionality (2000) and Method of Operation (10000) described in claims 1 to 8 where Method of operation activities (11500) containing “Post-event calculation of vehicle vector trajectory” (11500) is comprising “Estimating sensor error model” (11510) method
Being calculated in a way that:
“inertial sensor data set” is available as data output gathered from accelerometers, gyroscopes, as well as from magnetometers and temperature sensors
“external sensor data set” is available as data output gathered from Global navigation satellite system (GNSS) unit (110) (including latitude, longitude, heading, as well as altitude and dilution of precision) and optionally data from vehicle odometer such as speed.
“sensor data set” is available as composite information made out of “inertial sensor data set” and “external sensor data set”
where “Sensor error model” is being calculated in a way that:
“Final vehicle state” is available as a set of data consisting of vehicle position (geographic latitude, longitude and optionally altitude), vehicle attitude (roll, pitch and heading angle) and time.
“Predicted vehicle state” is available as a set of data consisting of vehicle position (geographic latitude, longitude and optionally altitude), vehicle attitude (roll, pitch and heading angle), vehicle speed vector and time, whereby the starting values for “predicted vehicle state” are available using recent inertial sensor measurements.
“Inertial sensor data set” is recorded to a circular buffer
New “inertial sensor data set” is calculated by compensating “inertial sensor data set” using values set in “sensor error model”
Current “predicted vehicle state” and “inertial sensor data set” are used to estimate a new “predicted vehicle state” by applying a known strap-down integrated navigation system apparatus and by solving navigation equations and known coordinate frame transformations.
If new measurements from “external data set” are available “innovation” is calculated as a difference between measurements from “external data set” and “predicted vehicle state”
“Innovation”, “external sensor data set” and “predicted vehicle state” are used to correct the “sensor error model” by applying one of the known apparatuses such as linear or non-linear estimators by plurality of the approaches.
“Predicted vehicle state” is updated according to “external sensor data set” measurements. (step “correction”)

29. Telematics system comprising T-Box (1000) apparatus and Back End Functionality (2000) and Method of Operation (10000) described in claims 1 to 8 and in claim 27 where Method of operation activities (11500) containing “Post-event calculation of vehicle vector trajectory” (11500) is comprising “Crash trajectory reconstruction” (11520) method
“sensor error model T0” is available as “sensor error model” obtained at moment T0.
value of “Interval 0” is set as a time duration, value starting with T(minus1) and ending with T0, being “Pre-Crash Interval”
“Interval 2” as a time duration is set, with the starting value T1 and ending value T2, being “Post-Crash Interval”
“Interval 1” as a time duration is set, with the starting value TO and ending value T1, being “Crash Interval”
“Interval 3” as a time duration is set
“Crash trajectory reconstruction” is being calculated in a way that:
“inertial sensor data set” stored in a circular buffer for the whole duration of a crash is compensated using “sensor error model T0” before the crash and after the crash and resulting updated “inertial sensor data set” is stored to the memory
“Averaged global positioning satellite system unit (110) position” is calculated as an average of GPS positions from “external sensor data set” over interval 3.
“Averaged acceleration vector” is calculated as an average of accelerometer data from “inertial sensor data set” over “Interval 3”.
“Final roll” and “Final pitch” angles (defined according to the navigation frame convention) are calculated using trigonometry and “averaged acceleration vector”
“Averaged final heading” is calculated as an average of magnetometer heading data from “inertial sensor data set” over “Interval 3”.
“Final vehicle state” is calculated from “Averaged global positioning satellite system unit (110) position”, “final pitch”, “final roll” and “averaged final heading”
Method is further executed by using a “Final vehicle state” as initial condition in execution of an inverse kinematics trajectory calculation, wherein following steps are executed:
Stored “inertial sensor data set” is integrated in the reverse order over the interval T2==>T1 (interval 2) using plurality of the methods and the “Final vehicle state T1” is obtained.
By using “Final vehicle state T1” as starting a state, stored “inertial sensor data set” is integrated in the reverse order over interval T1==>T0 (interval 1) using plurality of the methods and “Final vehicle state TO” is obtained.
By using “Final vehicle state T0” as starting state, stored “inertial sensor data set” is integrated in the reverse order over interval T0==>Tminus1 (interval 0) using plurality of the methods and “Final vehicle state Tminus1” is obtained.

30. Telematics system comprising T-Box (1000) apparatus and Back End Functionality (2000) and Method of Operation (10000) described in claim 28 where Method of operation activities (11500) containing “Post-event calculation of vehicle vector trajectory” (11500) is comprising “Crash trajectory reconstruction” (11520) method where
“Averaged global positioning satellite system unit (110) position” and “averaged final heading” are improved by a collection of data obtained by an expert witness.

31. Telematics system comprising T-Box (1000) apparatus and Back End Functionality (2000) and Method of Operation (10000) described in claim 28 where Method of operation activities (11500) containing “Post-event calculation of vehicle vector trajectory” (11500) is comprising “Crash trajectory reconstruction” (11520) method where
“Averaged global positioning satellite system unit (110) position” and “averaged final heading” are improved by a collection of data obtained by external measurements.

32. Telematics system comprising T-Box (1000) apparatus and Back End Functionality (2000) and Method of Operation (10000) described in claims 1 to 26 with inclusion of the activities within Method of operation (11000): “Event Warning to Vehicle System (Driver) (11600), where the T-Box (1000) is issuing warnings by the plurality of the means (audio, video, belt fasting) to the driver, in the case when
a detected Event has occurred, by plurality of the Event manifestations
a combination of detected Events has occurred, by the plurality of the combinations of at least two Events
a related specific pre-defined statistics of an appearance of a specific Event or of a Group of Events has occurred, by plurality of the detected Events
whereby the driver is addressed by an interface entity (320) or (340).

33. Telematics system comprising T-Box (1000) apparatus and Back End Functionality (2000) and Method of Operation (10000) described in claims 1 to 26 with inclusion of the activities within Method of operation (11000): “Pre-Event Warning to Vehicle System (Driver)” (11600), where the T-Box (1000) is issuing warnings by the plurality of the means (audio, video, belt fasting) to the driver, in the case of a detected Event, or a set of Events by plurality of the Events that may happen in the future,
whereby the driver is addressed by an interface entity (320) or (340)
whereby the decision to issue an alert is based on the processing of past information based on:
occurred detected Event, by plurality of the Event manifestations
occurred combination of detected Events, by the plurality of combinations of at least two Events
occurred relevant specific pre-defined statistics of appearance of specific Event or Group of Events, by plurality of the detected Events
inputs from environment sensors
position of the vehicle

34. Telematics system comprising T-Box (1000) apparatus and Back End Functionality (2000) and Method of Operation (10000) described in claims 1 to 26 with an inclusion of the activities within Method of operation (11000): “Encryption and Multimedia Compressions” (11700), where the T-Box (1000) is executing data encryption by the plurality of the encryption solutions and deepness of the keying in the processor unit (130).

35. Telematics system comprising T-Box (1000) apparatus and Back End Functionality (2000) and Method of Operation (10000) described in claims 1 to 26 with an inclusion of the activities within Method of operation (11000): “Encryption and Multimedia Compressions (11700), where the T-Box (1000) is executing multimedia data compression by the plurality of the multimedia data compression in the processor unit (130).

36. Telematics system comprising T-Box (1000) apparatus and Back End Functionality (2000) and Method of Operation (10000) described in claims 1 to 26 with an inclusion of the activities within Method of operation (11700) being related to video capture action step activities: (11710, 11711, 11712, 11713, 11714), where Control System of the T-Box (1000) executed in T-Box processor unit (130), is initiating and enabling activity of the Video capture procedure, depending on at least one of the procedures
a) a regular time frame assigned activity of video capturing
b) a detected pre defined driving related Event
c) a detected pre defined Sensor Input through (330) entity
d) a driver wish, typically initiated by (320) entity

37. Telematics system comprising T-Box (1000) apparatus and Back End Functionality (2000) and Method of Operation (10000) described in claims 1 to 26 with an inclusion of the activities within Method of operation (11700) being related to audio capture action step activities: (11720, 11721, 11722, 11723, 11724), where Control System of the T-Box (1000) executed in T-Box processor unit (130) is initiating and enabling activity of the Audio capture procedure, depending on at least one of the procedures
a) a regular time frame assigned activity of audio capturing
b) a detected pre defined driving related Event
c) a detected pre defined Sensor Input through (330) entity
d) a driver wish, typically initiated by (320) entity

38. Telematics system comprising T-Box (1000) apparatus and Back End Functionality (2000) and Method of Operation (10000) described in claims 1 to 26, with an inclusion of the activities within Method of operation (11000): “Initialization of Event related Alerts” (11800), where the T-Box (1000) is initiating alerts to “out of the vehicle” world through an entity (120), whereby the alerts are issued upon:
occurring detected Event, by plurality of the Event
occurring combination of detected Events, by the plurality of the combinations of at least two Events
occurring relevant specific pre-defined statistics of an appearance of a specific Event or Group of Events, by plurality of the detected Events

39. Telematics system comprising T-Box (1000) apparatus and Back End Functionality (2000) and Method of Operation (10000) described in previous Claims, where the Back End functionality (2000) comprises additionally the Network Interface to external Charging Systems (2140), by the plurality of realization.

40. Telematics system comprising T-Box (1000) apparatus and Back End Functionality (2000) and Method of Operation (10000) described in previous Claims where the Back End functionality (2000) comprises additionally the Network Interface to external Charging Systems (2140), is a charging system of the long range wireless network service provider.

41. Telematics system comprising T-Box (1000) apparatus and Back End Functionality (2000) and Method of Operation (10000) described in claims 1 to 37, where the Back End functionality (2000) compromises additionally the Network Interface to External Data Base Systems (2130) by the plurality of the realization.

42. Telematics system comprising T-Box (1000) apparatus and Back End Functionality (2000) and Method of Operation (10000) described in previous claim 40 where the Back End functionality (2000) compromises additionally the Network Interface to External Data Base Systems (2130), where the external data base system is external data base system of the insurance company being SAP System.

43. Telematics system comprising T-Box (1000) apparatus and Back End Functionality (2000) and Method of Operation (10000) described in claim 40 where the Back End functionality (2000) compromises additionally the Network Interface to External Data Base Systems (2130), where the external data base system is external data base system of the insurance company being Oracle System.

44. Telematics system comprising T-Box (1000) apparatus and Back End Functionality (2000) and Method of Operation (10000) described in claims 1 to 37, where the Back End functionality (2000) compromises additionally WEB user Interface dedicated to the Users (2100) allowing personalized access to the proposed System, where the access rights are granted through WEB interfaces (2120) dedicated to supervision and Control (2120).

45. Telematics system comprising T-Box (1000) apparatus and Back End Functionality (2000) and Method of Operation (10000) described in claims 1 to 37, where the Back End functionality (2000) has in the scope of entity (2500) Charging Calculation functionality (2600), being realized by the plurality of the realizations, using information form entity (2200).

46. Telematics system comprising T-Box (1000) apparatus and Back End Functionality (2000) and Method of Operation (10000) described in claims 1 to 37, where the Method of operation activities (12000) are additionally supplemented by Method of operation “Back End Alert Actions” (12100), being realized by the plurality of the approaches, using information available from entities (2200) and (2300), being enriched by information coming from T-Box (100) related to pre defined events, whereby security organization networks are addressed (12110).

47. Telematics system comprising T-Box (1000) apparatus and Back End Functionality (2000) and Method of Operation (10000) described in claim 45, where the Method of operation activities (12000) are additionally expanded by Method of operation “Back End Alert Actions” (12100), being realized by the plurality of the approaches, using information available from entities (2200) and (2300) and being enriched by information coming from T-Box (100) related to pre defined events, whereby health & emergency organization networks are addressed (12120).

48. Telematics system comprising T-Box (1000) apparatus and Back End Functionality (2000) and Method of Operation (10000) described in claims 1 to 37, where the Method of operation activities (12000) are additionally supplemented by Method of operation “Back End Alert Actions” (12100), being realized by the plurality of the approaches, using information available from entities (2200) and (2300) and being enriched by information coming from T-Box (100) related to pre defined events, whereby vehicle & driver is addressed, (12130) and (12140).

49. Telematics system comprising T-Box (1000) apparatus and Back End Functionality (2000) and Method of Operation (10000) described in claims 1 to 37 and in claim 44, where the Method of operation activities (12000) are additionally supplemented by Method of operation “Charging functionality” (12700), being realized by the plurality of the approaches, using information available from entity (2600), whereby the calculated information from (2600) is prepared for charging users of the proposed system directly, by plurality means including explicitly credit card charging, debit card charging, billing through IP network, or dispatching of post printed paper bills.

50. Telematics system comprising T-Box (1000) apparatus and Back End Functionality (2000) and Method of Operation (10000) described in claims 1 to 37 and in claim 44, where the Method of operation activities (12000) are additionally supplemented by Method of operation “Interface to the External Data Base Systems & Charging Systems” (12800), being realized by the plurality of the approaches and realizations, using information available from entity (2600), and preparing the data to be provided to Entity (2140) and (2130).

51. Method of Operation related to Service Company Business Model (20100), which is utilizing T-Box (1000) apparatus and Back End Functionality (2000) and Method of Operation (10000) described in claims 1 to 42,
where in addition to Tracking information of the vehicle, being accessible from WEB service at least one of innovative additional services are being provided to the system user:
SERVICE ITEM (20110) Vehicle Trajectory Report in case of pre defined event reports from (12200)
SERVICE ITEM (20120) Vehicle driving profiles based on statistics related to specific pre-defined events, being conceptually defined and calculated by the (11400), and processed by (11200), (12300), (12500) and (12600)
SERVICE ITEM (20130) Vehicle warning in case of pre defined events, being calculated by (11300)
SERVICE ITEM (20140) Commitment of automatically placing alerts to the vehicle according to (11600)
SERVICE ITEM (20150) Commitment of automatically placing alerts to the security and safety organizations according to (12100)
Where at least one of the following customers is addressed:
transportation fleets like:
vehicle leasing companies,
public fleets like school busses,
Taxi organizations,
logistics companies, like post delivery companies
organizations like chemistry-, oil-, steel-, mining-industry (with more than 100 vehicles in fleet)
organizations having own fleets, like emergency organization (fire protection, health), defense organizations, security organizations (police)
smaller enterprises (with smaller fleets under 100 vehicles)
private organizations, like “worried parents organization” and “community kids tracking”, being interested in tracking the cars of their kids to assess the specific pre-defined events by specific group of vehicles
private persons, with a need to have service for one or more vehicle
automotive national Clubs, for extending their services to drivers, by typically reselling the services from a Service company
Certification, Vehicle control as well as Automotive repair chain organizations, for extending their services to drivers by typically reselling the services from a Service Company
where charging is executed like:
upfront per vehicle payment (partially covering cost 1 for installation of the (1000) in the vehicle and partially covering cost 2 for T-Box (1000), where the partial coverage 1 and partial coverage 2 may vary from 0% to 100%)
payment for the services in more than one installment

52. Method of Operation related to Service provisions to Insurance Companies (20200), which is utilizing T-Box (1000) apparatus and Back End Functionality (2000) and Method of Operation (10000) described in claims 1 to 44,
where at least one of innovative additional services is offered:
SERVICE ITEM 1 (20210) Vehicle driving profiles based on statistics related to specific pre-defined events, being conceptually defined and calculated by the (11400), and processed by (11200), (12300), (12500) and (12600).
SERVICE ITEM 2 (20220) Vehicle Trajectory Report in case of the pre defined event reports, from (12200), where trajectory recovery and crash report in the case of the incident / crash is an essential and very valuable service provision.
SERVICE ITEM 3 (20230) Tracking information of the vehicle, being accessible from WEB service (state of the art), but due to newly proposed system (apparatus+method of operations) customer is obtaining AT LEAST one additional service like:
Commitment to automatically supply alerts to a vehicle according to (11600)
Commitment to automatically supply alerts to security and safety organizations according to (12100)
where charging to Insurance companies is executed like:
upfront payment partially covering cost 1 for installation of the (1000) in the vehicle and partially covering cost 2 for T-Box (1000), where the partial coverage 1 and partial coverage 2 may vary from 0% to 100%)
payment for the services in more than one installment

53. Method of Operation related to Service provisions for “Traffic Organizations” (20300), which is utilizing T-Box (1000) apparatus and Back End Functionality (2000) and Method of Operation (10000) described in claims 1 to 44,
where traffic organizations are one of the listed organisations:
Traffic organizations providing traffic regulation services
Traffic organizations providing traffic optimization services
Traffic organizations providing charging for used infrastructure in a specific geographical areas
where at least one of innovative additional services is offered:
SERVICE ITEM (20310) Cluster (more than one vehicles in the monitoring system) driving profiles based on statistics related to specific pre-defined events, being conceptually defined and calculated by the (11400) and processed by (11200), (12300), (12500) and (12600).
SERVICE ITEM (20320) Vehicle (individual) driving profiles based on statistics related to specific pre-defined events, being conceptually defined and calculated by the (11400) and processed by (11200), (12300), (12500) and (12600).
SERVICE ITEM (20330) Pre defined event reports, from (12200), where pre-defined events reports are used for “Pay HOW you drive” (related to payment per pre defined Event) business model, imposing that the service provider being in charge (a traffic regulatory company) is issuing the charges related to specific events.
SERVICE ITEM (20340) Tracking information of the vehicle, being accessible via WEB service (state of the art), but due to newly proposed system (apparatus+method of operations) traffic participants are advantageously obtaining additional features like:
automatically raising alerts to the vehicle according to (11600) if the traffic participants are violating the pre-defined rules in areas and/or if the specific events are important for participant security:
Automatically raising alerts to the security and safety organizations according to (12100) in a specific geographical area
where: Traffic participant pays to “Traffic Organization” according the following options:
Specific regular (time) fees depending on the customer profile
Specific payments (fees and punishment fees) for the appearance of the pre-defined events on “pay how you drive” basis
where the “Traffic Organization” is paying typically fees in regular data intervals for using technology, services from general service providers, or paying in a manner of one time payment and providing services of the systems and its operation by its own stuff.
